(19) United States
(12) Patent Application Publication
(10) Pub. No.: US 2019/0121334 A1
(43) Pub. Date: Apr. 25, 2019

(54) ADVISORY SYSTEM FOR INDUSTRIAL PLANTS

(71) Applicant: Baker Hughes, a GE Company, LLC, Houston, TX (US)

(72) Inventors: Guiju Song, Schenectady, NY (US); Mathilde Bieber, Garching Bei Munchen (DE); Trevor Kirsten, Garching B. Munchen (DE); Simon Antony Crawley-Boevey, Hammersmith (GB); Fabio Mazzocchetti, Houston, TX (US); Xing Wang, Houston, TX (US)

(21) Appl. No.: 16/169,076

(22) Filed: Oct. 24, 2018

Related U.S. Application Data
(60) Provisional application No. 62/576,647, filed on Oct. 24, 2017.

(51) Int. Cl. G05B 19/418; G06N 5/04; G06Q 10/06; G06F 3/0484

(52) U.S. Cl. CPC G05B 19/41885; G06F 3/0484; G06Q 10/06315; G06N 5/046

(57) ABSTRACT

A monitoring system can include a dashboard including a graphical user interface display space, and a digital twin validation system including a processor configured to perform operations. The operations can include rendering, in a graphical user interface display space, a first interactive graphical object characterizing a first input value indicative of a first oil and gas machine of a plurality of oil and gas industrial machines. The operations can also include receiving data characterizing user interaction with the first interactive graphical object and indicative of the first input value. The operations can further include determining, by a predictive model, data characterizing a characteristic property of a plurality of components of the first oil and gas machine over a first time period.

### RELATED APPLICATION

This application claims priority under 35 U.S.C. § 119(e) to U.S. Provisional Patent Application No. 62/576,647 filed on Oct. 24, 2017, the entire content of which is hereby expressly incorporated by reference herein.

### BACKGROUND

Industrial processing plants, such as liquefied natural gas (LNG) plants and oil refineries, can be complex facilities having numerous sub-systems and components. As the plants operate, deviation from design operating conditions and routine wear and tear can cause subsystems and components of the plants to operate at less than peak efficiency, thus lowering production output of the entire plant.

### SUMMARY

Due to the complexity of LNG plants (e.g., oil and gas industrial machines), it can be challenging to identify which subsystems and components are contributing to overall production loss. Systems, devices, and methods for attributing production loss within an industrial facility are provided.

In an aspect, a method can include rendering, in a graphical user interface display space, a first interactive graphical object characterizing a first input value indicative of a first oil and gas machine of a plurality of oil and gas industrial machines. The method can also include receiving data characterizing user interaction with the first interactive graphical object and indicative of the first input value. The method can further include determining, by a predictive model, data characterizing a characteristic property of a plurality of components of the first oil and gas machine over a first time period. The determining can be based in part on data characterizing one or more operating parameters of the plurality of components over a second time period. The method can also include rendering, in the graphical user interface display space, a first plot of the determined data characterizing the characteristic property over the first time period and a second plot of data characterizing the characteristic property over the second time period.

One or more of the following features can be included in any feasible combination.

The method can further include determining the data characterizing the characteristic property over the second time period from the data characterizing one or more operating parameters of the plurality of components of the first oil and gas machine.

The method can further include generating, by the predictive model, a plurality of recommendations for the first oil and gas machine. The plurality of recommendations can be indicative of a plurality of predicted outputs of the plurality of components of the first oil and gas machine. The method can further include rendering, in the graphical user interface display space, one or more interactive graphical objects representative of one or more of the plurality of predicted outputs. The method can further include receiving, from a user, data characterizing selection of one or more of the plurality of predicted outputs by the user.

The method can include generating, by the predictive model, a first forecast of the characteristic property of the plurality of components over the first time period. The first forecast can be based on selection of a first predicted output of the plurality of predicted outputs and can be indicative of a first plurality of future values of the characteristic property. The predictive model can also generate a second forecast of the characteristic property of the plurality of components over the first time period. The second forecast can be based on selection of a second predicted output of the plurality of predicted outputs and indicative of a second plurality of future values of the characteristic property. The method can further include rendering, in the graphical user interface display space, a first forecast plot of the first forecast of the characteristic property over the first time period, and a second forecast plot of the second forecast of the characteristic property over the first time period.

The method can further include generating, by the predictive model, a third forecast of the characteristic property of the plurality of components over the first time period. The third forecast can be based on selection of the first predicted output and the second predicted output. In another implementation, the first forecast of the characteristic property of the plurality of components over the first time period can be determined by the predictive model based on the one or more operating parameters of the plurality of components over the second time period and an input recommendation for the first oil and gas machine provided by the user. In yet another implementation, the method can further include updating the predictive model, the updating can include determining one or more system coefficients associated with the plurality of components of the first oil and gas machines.

The predictive model can be configured to calculate the one or more system coefficients based on a characteristic mathematical representation of the plurality of components of the first oil and gas industrial machine. The characteristic mathematical representation can include a system of equations that can calculate the one or more system coefficients based, at least in part, on data characterizing a user input. In another implementation, the characteristic property can be indicative of performance of the plurality of components over the first time period.

The method can further include receiving the data characterizing one or more operating parameters of the plurality of components of the first oil and gas machine. The data characterizing one or more operating parameters can be detected by one or more sensors coupled to the first oil and gas machine. In another implementation, the method can further include rendering in the graphical user interface display space, a second interactive graphical object representative of one or more alert messages associated with the first oil and gas industrial machine of the plurality of oil and gas industrial machines.

The method can further include receiving data characterizing user interaction with the second interactive graphical object indicative of selection of a first alert message of the one or more alert messages. The method can also include rendering, in the graphical user interface display space, a third interactive graphical object characterizing a third input value indicative of a repair request associated with the first industrial machine. The method can further include receiving data characterizing user interaction with the third interactive graphical object. The method can also include generating a work order for the repair request associated with the industrial machine.

In another aspect, a system can include at least one data processor, and memory coupled to the at least one data processor. The memory can store instructions to cause the at least one data processor to perform operations. The operations can include rendering, in a graphical user interface display space, a first interactive graphical object characterizing a first input value indicative of a first oil and gas machine of a plurality of oil and gas industrial machines. The operations can also include receiving data characterizing user interaction with the first interactive graphical object and indicative of the first input value. The operations can further include determining, by a predictive model, data characterizing a characteristic property of a plurality of components of the first oil and gas machine over a first time period. The determining can be based in part on data characterizing one or more operating parameters of the plurality of components over a second time period. The operations can also include rendering, in the graphical user interface display space, a first plot of the determined data characterizing the characteristic property over the first time period and a second plot of data characterizing the characteristic property over the second time period. In another implementation, the operations can further include determining the data characterizing the characteristic property over the second time period from the data characterizing one or more operating parameters of the plurality of components of the first oil and gas machine.

One or more of the following features can be included in any feasible combination.

The operations can further include generating, by the predictive model, a plurality of recommendations for the first oil and gas machine. The plurality of recommendations can be indicative of a plurality of predicted outputs of the plurality of components of the first oil and gas machine. The operations can also include rendering, in the graphical user interface display space, one or more interactive graphical objects representative of one or more of the plurality of predicted outputs. The operations can further include receiving, from a user, data characterizing selection of one or more of the plurality of predicted outputs by the user.

The operations can further include generating, by the predictive model a first forecast of the characteristic property of the plurality of components over the first time period. The first forecast can be based on selection of a first predicted output of the plurality of predicted outputs and indicative of a first plurality of future values of the characteristic property. The operations can also include generating, by the predictive model a second forecast of the characteristic property of the plurality of components over the first time period. The second forecast can be based on selection of a second predicted output of the plurality of predicted outputs and indicative of a second plurality of future values of the characteristic property. The operations can further include rendering, in the graphical user interface display space, a first forecast plot of the first forecast of the characteristic property over the first time period, and a second forecast plot of the second forecast of the characteristic property over the first time period.

The operations can further include generating, by the predictive model, a third forecast of the characteristic property of the plurality of components over the first time period. The third forecast can be based on selection of the first predicted output and the second predicted output. In another implementation, the first forecast of the characteristic property of the plurality of components over the first time period can be determined by the predictive model based on the one or more operating parameters of the plurality of components over the second time period and an input recommendation for the first oil and gas machine provided by the user. In yet another implementation, the operations can further include updating the predictive model. The updating can include determining one or more system coefficients associated with the plurality of components of the first oil and gas machines.

In yet another aspect, a monitoring system can include a dashboard including a graphical user interface display space, and a digital twin validation system including a processor configured to perform operations. The operations can include rendering, in a graphical user interface display space, a first interactive graphical object characterizing a first input value indicative of a first oil and gas machine of a plurality of oil and gas industrial machines. The operations can also include receiving data characterizing user interaction with the first interactive graphical object and indicative of the first input value. The operations can further include determining, by a predictive model, data characterizing a characteristic property of a plurality of components of the first oil and gas machine over a first time period. The determining can be based in part on data characterizing one or more operating parameters of the plurality of components over a second time period. The operations can also include rendering, in the graphical user interface display space, a first plot of the determined data characterizing the characteristic property over the first time period and a second plot of data characterizing the characteristic property over the second time period.

### DESCRIPTION OF DRAWINGS

FIG. 1 is a system block diagram of an exemplary embodiment of an advisory system for attributing production loss within an industrial facility;

FIG. 2 is a view of an exemplary graphical user interface (GUI) of the advisory system shown in FIG. 1;

FIG. 3 is a view of the GUI showing an opened case;

FIG. 4 is a view of the GUI that shows forecasted production data and a loss attribution plot;

FIG. 5 is a view of the GUI that shows a process flow diagram of a refrigeration subsystem as well as recommendations to recover production losses;

FIG. 6 is a view of the GUI that shows a window requesting permission to connect to a process simulation module;

FIG. 7 a view of the GUI that shows a graphical representation of a digital model of a component of a subsystem ;

FIG. 8 is a view of the GUI that includes a window that illustrates a progress bar characterizing progress of an analysis;

FIG. 9 is an updated view of the view shown in FIG. 7;

FIG. 10 is an updated view of the view shown in FIG. 5, including a user defined recommendation;

FIG. 11 is the view from FIG. 10 showing two selected recommendations;

FIG. 12 is a view of the GUI showing scenarios forecasted production based on the selected recommendations;

FIG. 13 is the view from FIG. 12 showing a selected scenario;

FIG. 14 an updated view of the view shown in FIG. 4

FIG. 15 a view of a GUI of an advisory system that can be used for oil refinery applications;

FIG. 16 is a flow chart of an exemplary method providing a user data characterizing production loss of an industrial plant;

FIG. 17 a block diagram that illustrates communication between sensors, an advisory system, and a user device, to provide a user with production loss data;

FIG. 18 a block diagram that illustrates data flow associated with providing a user with performance recovery information; and

FIG. 19 a block diagram that illustrates communication between sensors, an advisory system, and a user device, to provide a user with production loss data if sensor data is unavailable.

FIG. 20 is a view of an exemplary GUI of the advisory system for an oil refinery;

FIG. 21 is a view of an exemplary view the GUI for an oil refinery showing an opened case;

FIG. 22 is a production plot of production data and a loss attribution chart for an exemplary oil refinery;

FIG. 23 is an information panel that can generally be similar to the information panel shown in FIG. 5;

FIG. 24 is a pop-up windows that shows plots of production forecasts associated with an alert shown in FIG. 23.

FIG. 25 is the information panel shown in FIG. 23, with include a blank card identified;

FIG. 26 is a portion of a view of a GUI that can be utilized for oil refineries that shows a block diagram of a portion of an oil refinery, and can generally function similarly to the view 500 shown in FIG. 7;

FIG. 27 a portion of a view of a GUI that can be utilized for oil refineries that shows an information panel that can generally be similar to the information panel shown in FIGS. 10 and 11.

FIG. 28 shows examples of plots of forecasted production for an oil refinery that can be shown in an information panel of a view that can generally be similar to the view shown in FIG. 12;

FIG. 29 is an updated view of the view shown in FIG. 15, with a forecasted production slider in a first position;

FIG. 30 is the updated view shown in FIG. 29 with the forecasted production slider in a second position;

FIG. 31 a view of the GUI that can be used for oil refineries that shows production, loss attribution, and recovery buttons;

FIG. 32 shows another view of a GUI that can be used for oil refineries that shows a production recovery waterfall chart.

FIG. 33 is another view, or window, that can be shown to illustrate forecasted production and/or efficiency of the subsystem and/or component of an oil refinery

FIG. 34 is a view showing a production recovery waterfall chart corresponding to another recommended action to recover lost production;

FIG. 35 is a portion of a view that shows a block diagram of a portion of an oil refinery, where a user can adjust certain connections, parameters, specifications, and/or user variables;

FIG. 36 is a portion of a view that shows a production recovery chart corresponding to user input data;

FIG. 37 is a view of a GUI that can be used with oil refineries that shows forecasted production, revenue gained from avoiding lost production, and other information related to the oil refinery; and

FIG. 38 is a schematic illustration of an exemplary hierarchy of an asset.

### DETAILED DESCRIPTION

Industrial processing plants, such as liquefied natural gas (LNG) plants and oil refineries, can be complex facilities, which may have numerous sub-systems and components. As the plants operate, deviation from design operating conditions and routine wear and tear can occur, which can cause subsystems and components of the plants to operate at less than peak efficiency. This can lower production output of the entire plant. Due to the complexity of the plants, it can be challenging to identify which subsystems and components are contributing to overall production loss and by how much.

The current subject matter can provide a tool and user interface for attributing production loss within an industrial facility. The current subject matter can process sensor data from an industrial plant, compare that data to a digital model of the plant, and/or identify which subsystems are contributing to production loss. It can be desirable to monitor the operation of the various components separately as this can provide an insight into the cause of production loss. This can also allow the user to swiftly and efficiently address the loss in production. The loss can be visualized as a waterfall. The current subject matter can provide recommendations and/or actions to be taken, provide forecasts of production output (e.g., future predictions), and can provide predictions of future breakdowns. The current subject matter can provide a plant operator with actionable insights to operate a plant efficiently and cost effectively. Other embodiments are within the scope of the disclosed subject matter.

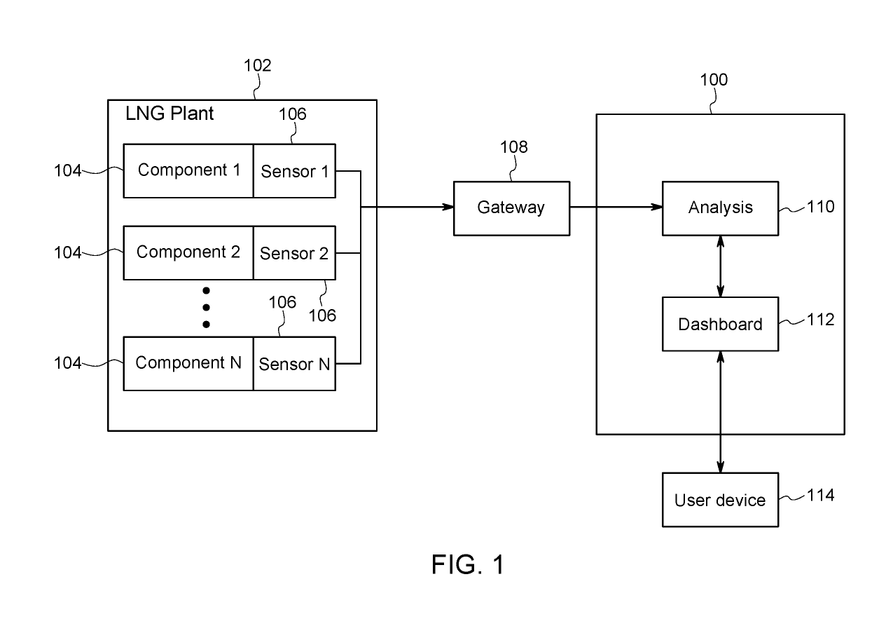

FIG. 1 illustrates an exemplary system block diagram of an embodiment of an advisory system 100 for attributing production loss within an industrial facility. The advisory system can also be configured to provide a plant operator with actionable insights to operate the plant efficiently and effectively. In the illustrated embodiments, the advisory system 100 is operably coupled to liquefied natural gas (LNG) plant 102 that includes a number of components 104. Each of the components 104 can have one or more sensors 106 operably coupled thereto for measuring operating values of the components 104. For example, the sensors 106 can measure temperatures, pressures, flow rates, compositions fluids, etc. The sensors 106 can communicate with the advisory system 100 via a gateway 108 (e.g., a router). The advisory system 100 can also be operably coupled to other type of facilities as well.

The advisory system 100 can include an analysis module 110 and a dashboard 112. The analysis module 110 can be configured to process data from the sensors 106 and generate operational data characterizing an operational status of the LNG plant. For example, the analysis module 110 can receive sensor data from the sensors 106, process the sensor data, compare sensor data to corresponding model data from a digital model of the plant, and identify which components 104, or subsystems, are contributing to production loss. The analysis module 110 can generate forecasts of production output (e.g., future predictions), as well as predictions of future breakdowns. In some embodiments, the analysis module 110 can generate forecasts of production output, and predict future breakdowns (e.g., up to three months in advance or beyond). The analysis module 110 can also generate actionable insights that a plant operator can use to operate a plant efficiently and cost effectively.

The analysis module 110 can provide the operational data, including data characterizing production loss, recoverable production, forecasts of production output, and predictions of future breakdowns, and actionable insights, to the dashboard 112.

The dashboard 112 can be configured to facilitate communication between the analysis module 110 and a user device 114. The dashboard 112 can receive the operational data, format the operational data, and create instructions that the user device 114 can use to render a graphical user interface that can provide the user with some, or all, of the operational data, as desired. For example, the dashboard 112 can receive the production loss data from the analysis module 110, format the production loss data, and generate instructions for rendering the production loss data on a display of the user device 114.

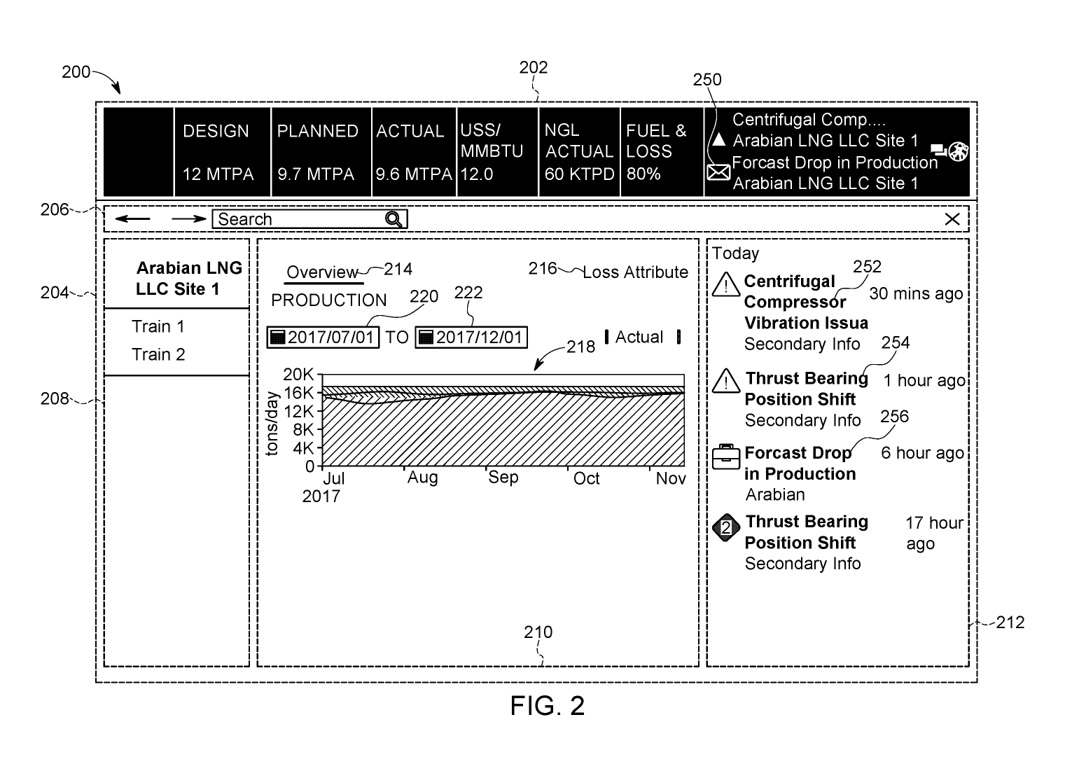

FIG. 2 shows a view 200 of an exemplary graphical user interface GUI of an advisory system that can be rendered on the user device 114. The GUI includes a status bar 202 configured to provide a user with basic information regarding production of the LNG plant 102. The GUI can also include a data window 204 that can include various graphical elements that can be used to provide the user with information regarding a status of the LNG plant 102. For example, in the illustrated view 200, the data window 204 includes a search panel 206, a menu panel 208, an information panel 210, and/or a notification panel 212.

The menu panel 208 can include interactive tabs, or buttons that can allow the user to navigate through the interface to view information regarding various subsystems, or components of the LNG plant 102. For example, the selected tab can determine information is shown in the information panel 210. As shown in FIG. 2, the “Arabian LNG LLC Site 1” tab is selected. In some embodiments, if the user selects another tab (e.g., “Train 2”), the user device 114 can send a command to the dashboard 112 requesting data related to Train 2. The dashboard can communicate with the analysis module 110 to receive operational data related to Train 2, format the operational data, and generate instructions for rendering the production loss data on a display of the user device 114. The formatted data and the instructions can be provided to the user device 114 to render appropriate information on the display of the user device 114.

The information panel 210 can be configured to provide the user with information regarding production of the LNG plant 102. In the illustrated view 200, the information panel 210 includes interactive buttons 214, 216 that can allow the user to view an overview of production of the LNG plant 120 or loss attribution of the LNG plant 120. The interactive overview button 214 selected in FIG. 2. With the interactive overview button 214 selected, the information panel 210 shows a plot 218 that includes production data characterizing amounts of production over a period of time. The plot 218 shows an actual production amount, a design production amount, and a target production amount. The information panel 210 also includes interactive buttons 220, 222 that allow the user to adjust the range of dates for which the plot 218 shows production data.

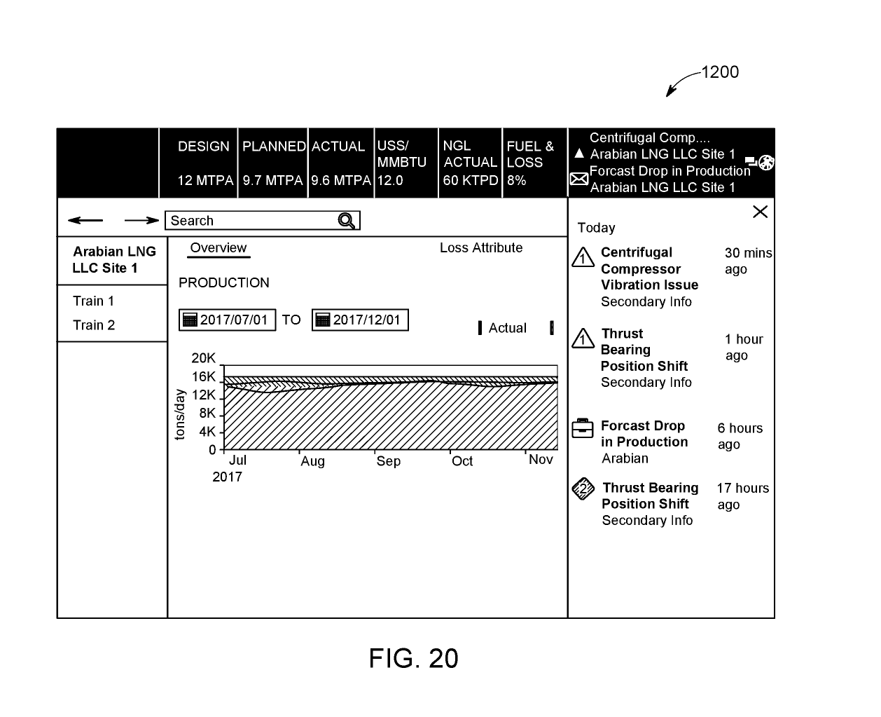

Although the view 200 of the GUI have been described with regard to a LNG production plant, the current subject matter is not limited to LNG production plants. For example, the current subject matter can include a recover advisory system for an oil refinery and include a GUI. FIG. 20 shows a view 1200 of a GUI that can be used for oil refinery applications. The view 1200 can include features similar to those described with respect to view 200 shown in FIG. 2. For example, the GUI in FIG. 20 can present an automatically generated SMS message (e.g., related to an urgent notification) for a user. In one implementation, the SMS message can be sent on behalf of an operations manager. The user can open the notification by clicking on an icon representative of the SMS message. Clicking on the icon can open a dialog box that can include instructions for the user (e.g., response strategy for responding to an alarm). The GUI in FIG. 20 can include one or more of a graph of historic gasoline production loss, a graph of forecast of gasoline production loss, relevant messages exchanged among users (e.g., operations manager, plant manager, etc.). The user can select a time range to display the historic/forecast plots.

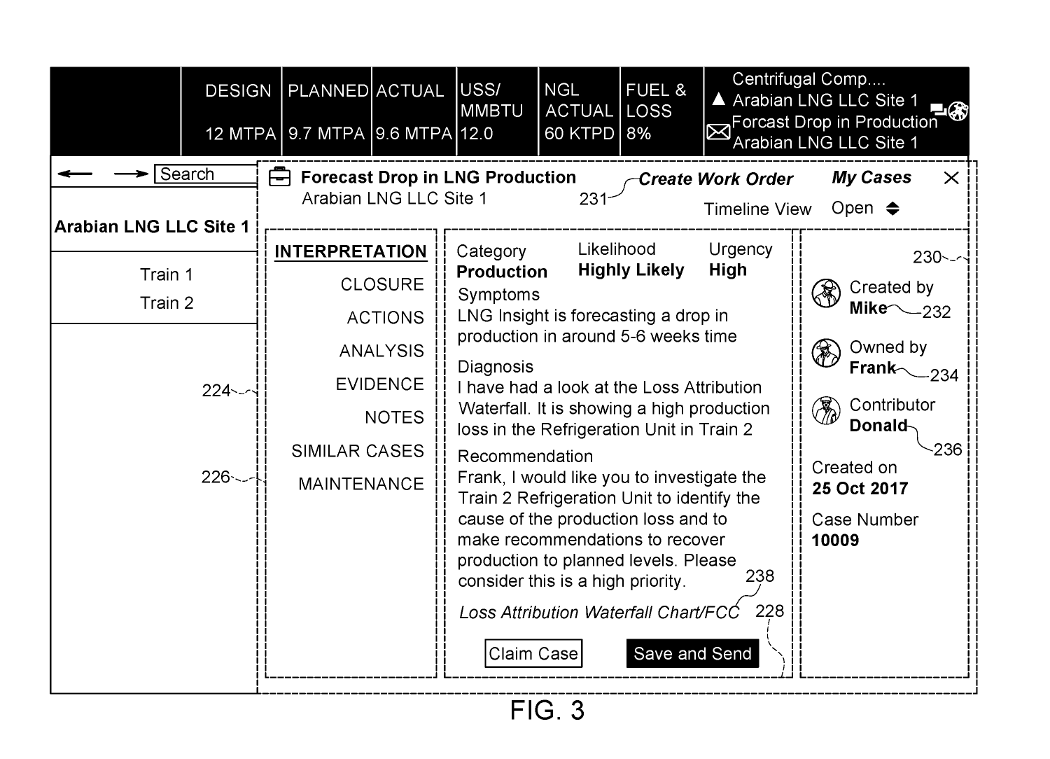

The notification panel 212 can be configured to provide a user with alerts related to operation of the LNG plant 102. The notification panel 212 can also provide notifications related to open cases, or work orders. As shown in the illustrated view 200, the notification panel includes three alerts, and one notification regarding a case that has been opened to investigate a forecasted drop in production. Each of the alerts/notification can be an interactive button that a user can select to view more information regarding the alert/notification. For example, if the user selects the case notification, the GUI can show a case window 224 that provides information related to the opened case, as shown in FIG. 3. The case window 224 can include a menu panel 226, an information panel 228, and a profile panel 230. The case window 224 can also include an interactive button 231 to create a work order to address issues related to the case. For example, a user can create a work order to repair a specific component of the LNG plant 102.

The menu panel 226 can include interactive tabs, or buttons, that can allow the user to view various information related to the case. For example, each tab can control what information is displayed in the information panel 228. In the illustrated example, the “Interpretation” tab is selected.

The information panel 228 can be configured to provide the user with information related to the selected case. In the illustrated example, the information panel 228 shows information related to an interpretation of the forecasted drop in LNG production. The information panel 228 shows a category of the case, a likelihood that the predicted event (i.e. the forecasted drop in LNG production) will occur, and an urgency of the issue. The information panel can also include information related to the symptoms of the event, a diagnosis of the issue, and/or a recommendation.

The profile panel 230 can provide administrative information related to the case, and users associated with the case. As an example, a primary user 232 can open the case, provide information characterizing symptoms related to the predicted event, and assign the case to a secondary user 234. The secondary user can diagnose problems related to the symptoms, and can add information characterizing the diagnosis. Alternatively, the primary user can add information characterizing the diagnosis. In the illustrated example, the forecasted drop in LNG production is due to high production loss in a refrigeration unit in Train 2. In some cases, another secondary user 236 can be added to the case to provide information related to the diagnosis or recommendations. The primary user 232 or the secondary users 234, 236 can provide information related to the symptoms, diagnosis, and/or recommendation.

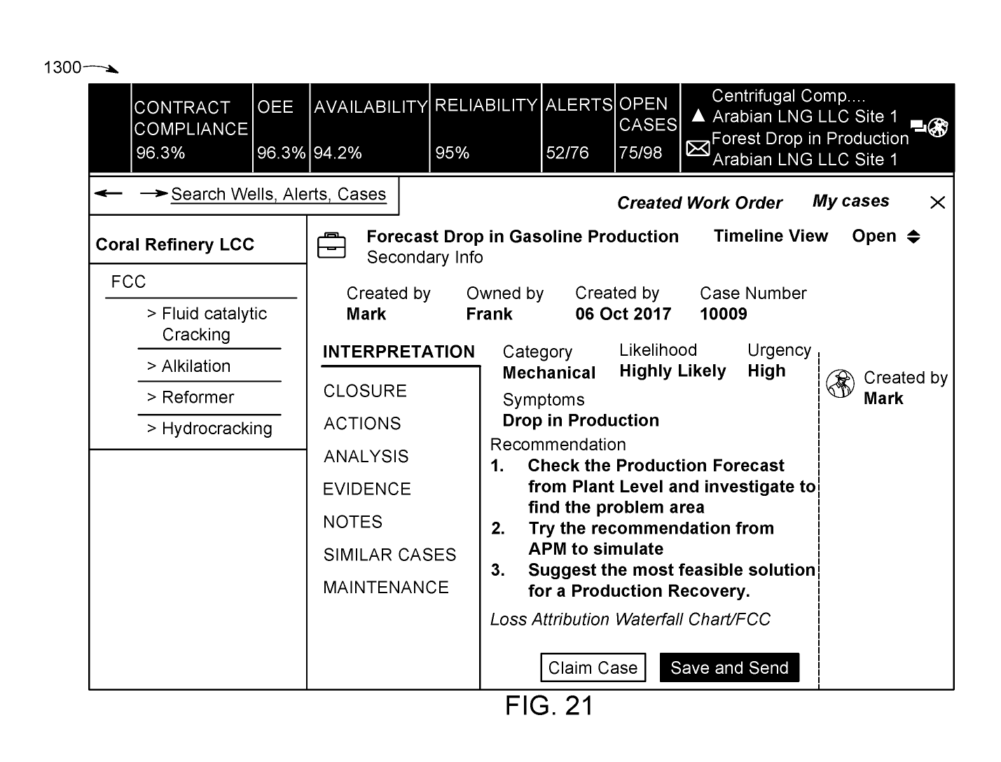

FIG. 21 is a view of an exemplary view 1300 of a GUI for an oil refinery showing an opened case window. The view 1300 can include features similar to those discussed above with respect to view 200 with the case window 224, shown in FIG. 3.

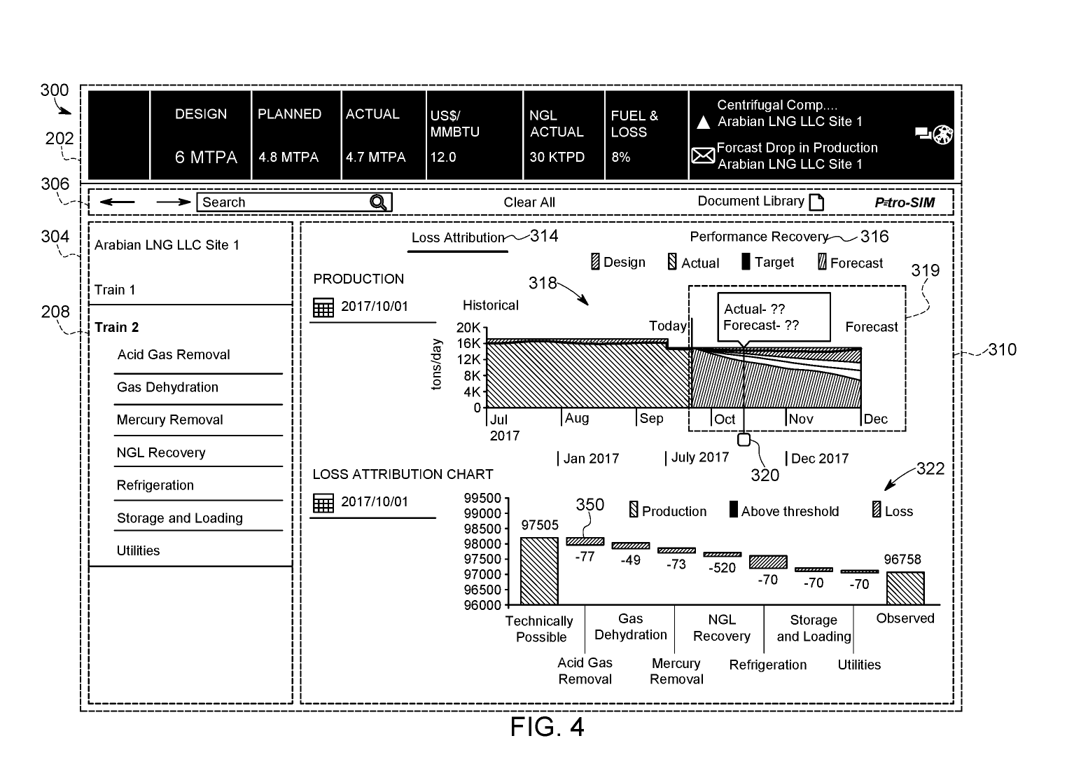

The information panel 228 can also include an interactive button that opens a view 300 of the GUI that shows a loss attribution chart related to the diagnosis of the case, as shown in FIG. 4. In the illustrated view 300, the GUI includes the status bar 202 and a data window 304 that can include various graphical elements that can be used to provide the user with information regarding a status of the LNG plant 102. The data window 304 includes a search panel 306, an information panel 310, and the menu panel 208. The search panel 306 can generally be similar to the search panel 206, shown in FIG. 2. As shown in FIG. 4, the “Train 2” tab of the menu panel 208 has been selected, and it includes expanded options, in the form of interactive buttons, that can be selected to view information related to specific subsystems, or components, of the Train 2 system. The status bar 202 can include an interactive notification icon 250. A user can receive auto-generated SMS of an urgent notification via the notification icon 250 (e.g., from an operation manager of the user). Clicking on the notification icon 250 can open the notification panel 212. The notification panel 211 can include, for example, alerts 252, 254 and a case icon 256.

The information panel 310 can include interactive buttons 314, 316 that can allow the user to view information related to loss attribution and performance recovery of Train 2, respectively. The interactive loss attribution button 314 is selected in FIG. 4. With the loss attribution button 314 selected, the information panel 310 shows a loss attribution chart 322, and a plot 318 of production data characterizing amounts of production over a period of time. The plot 318 shows an actual production amount, a design production amount, and a target production amount, and includes a forecasting section 319 that shows forecasted production values. The plot also includes an interactive slider 320 that can be moved along an X axis of the plot 318 to adjust the date for which data is displayed on the loss attribution chart 322.

The loss attribution chart 322 can display loss attribution data that characterizes maximum production values, observed production values, and lost production corresponding to various components, or subsystems, of the system (e.g. Train 2). For example, loss attribution chart 322 can include an interactive icon 350 which can be representative of the loss associated with a component of the system. Clicking on the interactive icon 350 can provide information about the subsystem (e.g., operational details associated with the sub-system) As shown in FIG. 2, loss attribution chart 322 can be a waterfall chart that provides information regarding a cumulative effect of lost production for each of the components, or subsystems, of the system. In some implementations, other charts/visualizations may be used. The maximum and observed production values can be observed as columns located on opposite ends of the loss attribution chart 322, with floating columns located between the maximum and observed production values. The floating columns can represent lost production corresponding to various components, or subsystems, of the system. The sum of the lost production for all of the components can represent the difference between maximum production value and the observed production value.

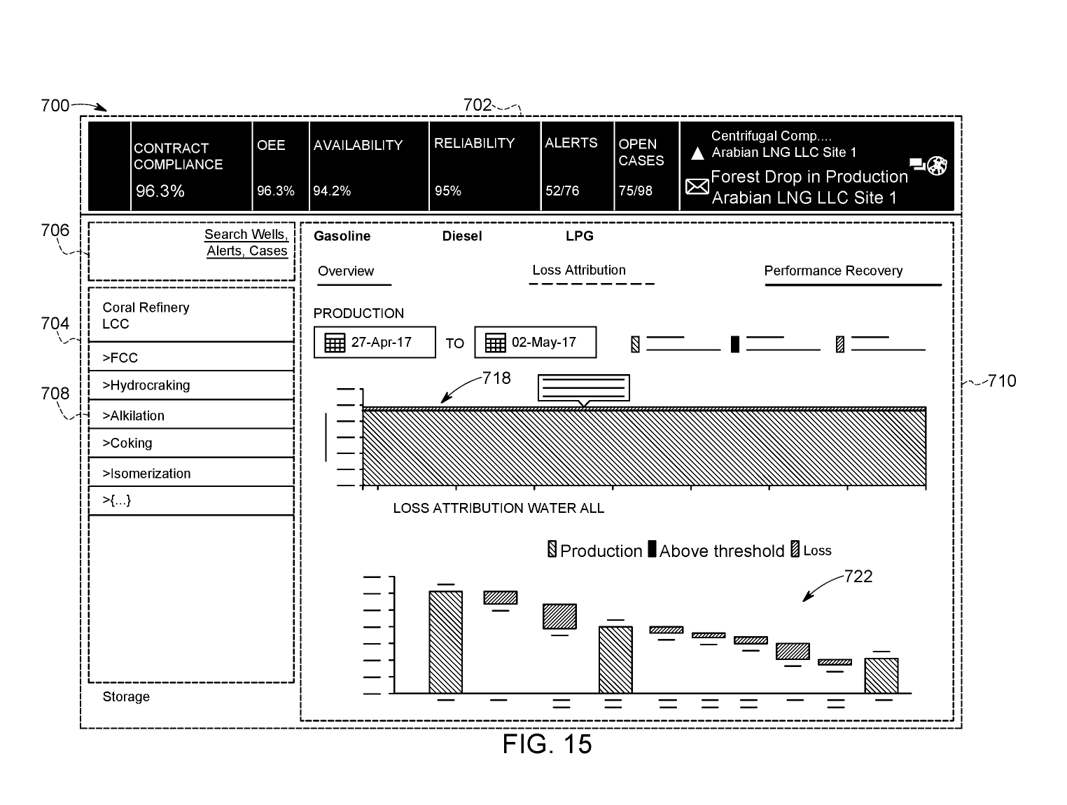

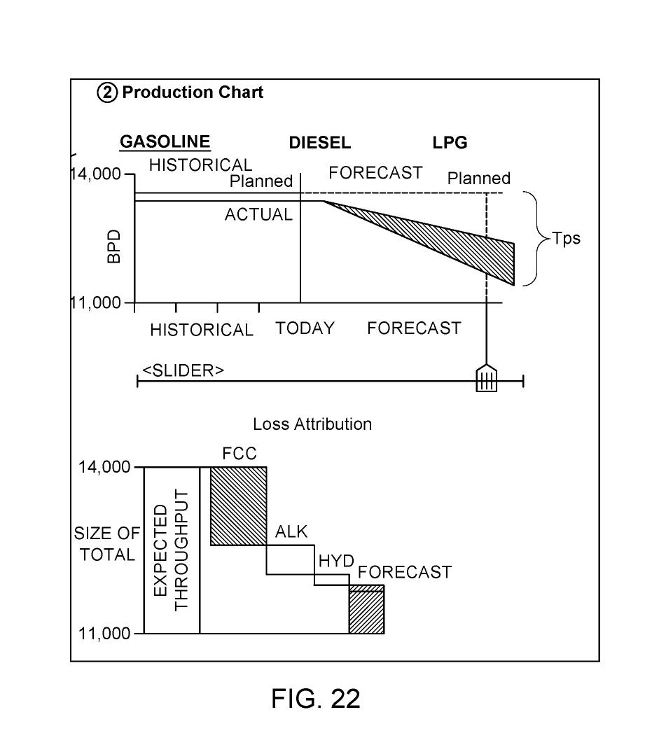

As described above, similar views of a GUI can be utilized for oil refinery applications. FIG. 22 shows a production plot of production data and a loss attribution chart for an exemplary oil refinery. The production plot and the loss attribution chart can generally be similar to the plot 318 and the loss attribution chart 322, shown in FIG. 4. In some implementations, the GUI in FIG. 22 can include graphical objects indicative of loss forecast of gasoline, diesel, LPG, etc. Clicking on a graphical object can display a corresponding loss forecast plot. In some implementations, the GUI can indicate a component based breakdown of the loss forecast. For example, a component/system (e.g. FCC unit) of the LNG plant that has the largest contribution to the loss forecast can be identified. A user can click on a graphical object representative of the component to access more information about the component (e.g., operations associated with the component). FIG. 15 shows a view 700 of a GUI that can be used for oil refinery applications. The view 700 can generally be similar to the view 300, shown in FIG. 4. The view 700 can include a status bar 702 configured to provide a user with basic information regarding production of the oil refinery. The GUI can also include a data window 704 that can include various graphical elements that can be used to provide the user with information regarding a status of the oil refinery. For example, in the illustrated view 700, the data window 704 includes a search panel 706, a menu panel 708, and an information panel 710. The information panel 710 can also include a loss attribution chart 722, and a plot 718 of production data characterizing amounts of production over a period of time.

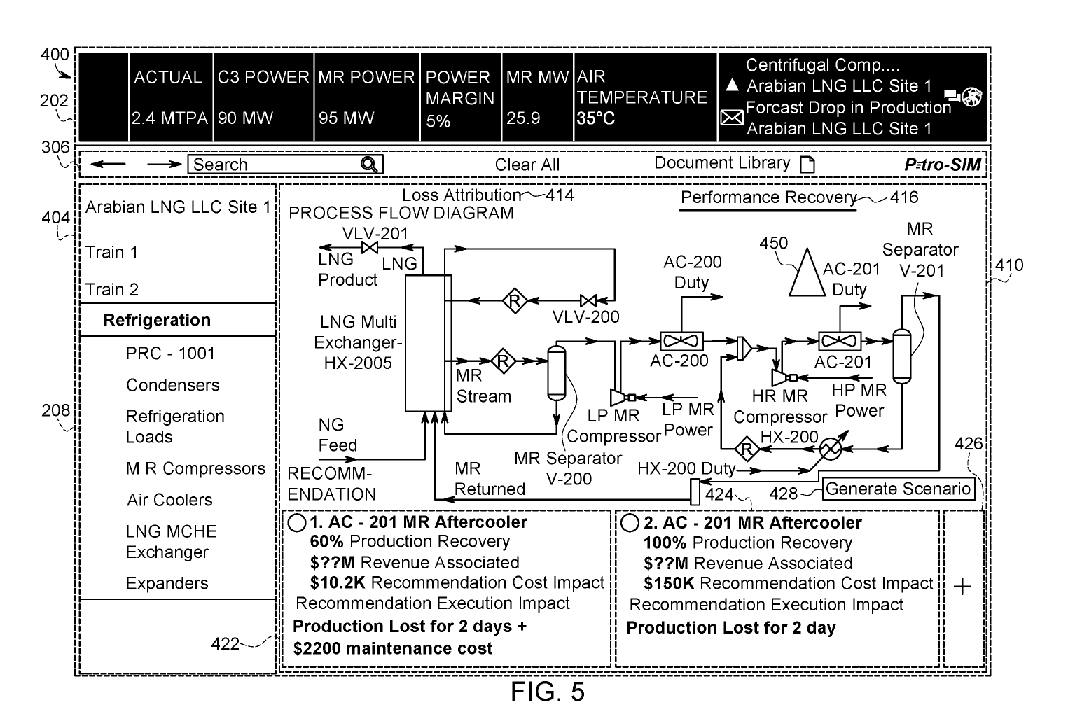

Referring to the view 300 shown in FIG. 4, the user can select one of the options from the menu panel 208 to view information related to a specific subsystem or component. For example, FIG. 5 shows a view 400 of the GUI in which the “Refrigeration” tab of the menu panel 208 has been selected.

In the illustrated view 400, the GUI includes the status bar 202 and a data window 404 that includes the search panel 306, the menu panel 208, and an information panel 410. As shown in FIG. 5, the “Refrigeration” tab of the menu panel 208 has been selected, and it includes expanded options, in the form of interactive buttons, that can be selected to view information related to specific subsystems, or components, of the refrigeration subsystem.

The information panel 410 can be configured to provide the user with information related to the refrigeration subsystem. In the illustrated view 400, the information panel 410 shows a process flow diagram of the refrigeration subsystem. The information panel 410 also includes interactive buttons 414, 416 that can allow the user to view information related to loss attribution performance recovery of the refrigeration subsystem of Train 2, respectively. The interactive performance recovery button 416 is selected in FIG. 5. With the performance recovery button 416 selected, the information panel 410 shows a process flow diagram 418 of the refrigeration subsystem, as well as selectable recommendation buttons, or cards 422, 424. The recommendation cards 422 can provide information related to operations such as, e.g., repairing, or replacing, certain components of the refrigeration subsystem to recover an amount of production of the system. For example, at a subsystem level the production recovery can relate to the components that make up a corresponding system. Production recovery data corresponding to the subsystem can characterize the sum of recovered production from components of the subsystem. Production recovery data corresponding to the train (e.g., Train 2) recovery can be the sum of recovered production from subsystems that make up the train. Similarly, production recovery data at plant level can characterize the sum of recovered production from the systems that make up the plant.

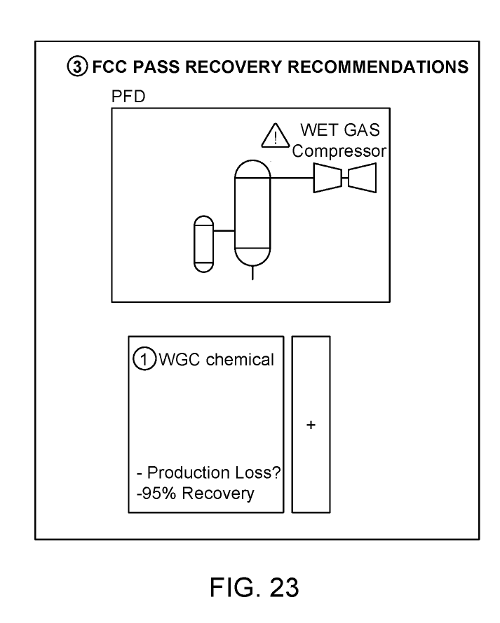

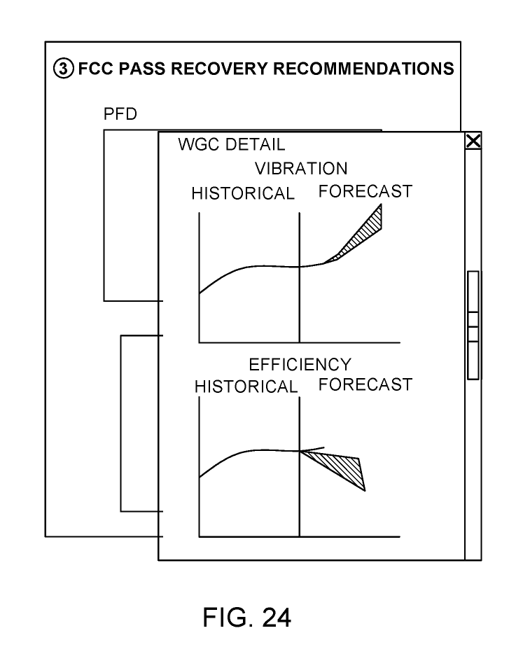

The cards 422, 424 can provide information regarding a percentage of production that can be recovered if the action is taken, an amount of revenue associated with the recovered production, a cost impact associated with performing the operation, and an execution impact. The execution impact can include information characterizing an impact on production, as well as costs of parts and/or labor associated with performing the operation. The information panel can also include a button 428 that the user can select to perform an analysis to forecasts the production output based on a selected recommendation. FIG. 23 shows a portion of a view of a GUI that can be utilized within oil refinery application. The view shows an information panel that can generally be similar to the information panel 410 shown in FIG. 5. The GUI can include an automatically generated recommendation (e.g., recommendation associated with a system alert). The GUI can include information associated with a component of the refinery (e.g., production recovery, revenue, recommendation cost impact, recommendation execution impact, etc.). In the illustrated example, the user can select an alert shown on the component of the refinery (e.g., a wet gas compressor (WGC)) and a window can pop up to show production forecasts as a result of production of the WGC, as shown in FIG. 24. The pop up can include forecast data associated with the component of the refinery (e.g., a forecast of vibration beyond the threshold of safe operation), efficiency of the component, etc. A user can return to the GUI in FIG. 23 by closing the pop-up.

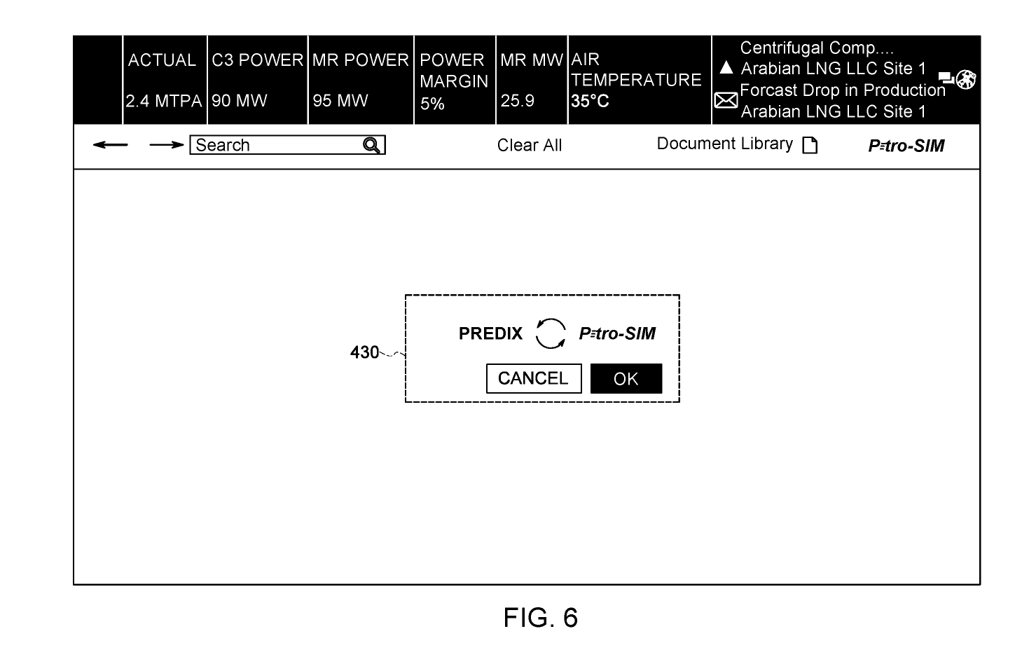

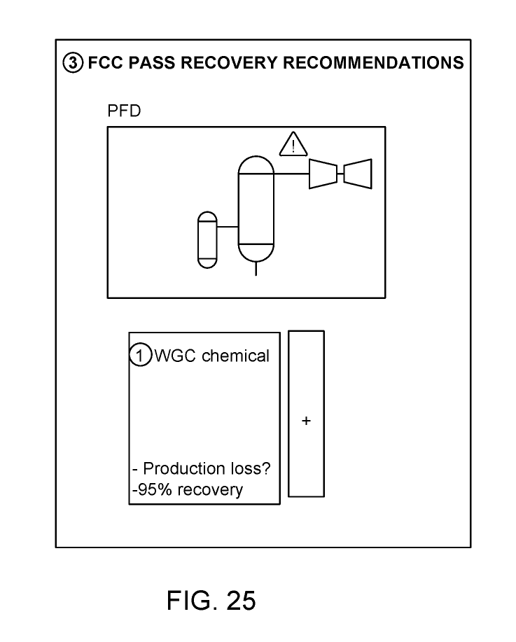

Referring to FIG. 5, the information panel 410 can also include a blank card 426 that the user can select to generate a user defined recommendation. If the user selects the blank card 426, the GUI can show a window 430 that requests permission to connect to a process simulation module (not shown) to access digital models of parts of the system, as shown in FIG. 6. The process simulation module can be configured to generate a digital model of all, or some, of the LNG plant 102. The view of the GUI for oil refinery applications can also include a blank card (e.g., represented by a graphical object with a “+” sign), as shown in FIGS. 23 and 25. In some implementations, a user can provide additional information/instructions using the blank card. After viewing the recommendation by the system, the user may want to perform additional diagnostic/optimization steps. Instructions for performing the additional diagnostics/optimization steps can be provided by clicking on the blank card. For example, clicking on the blank card can initiate a diagnostic/optimization model (e.g., petro-sim model of FCC). The information panel 410 can include an interactive icon 450 that can be indicative of information (e.g., alert) of a subsystem (e.g., refrigeration subsystem). The interactive icon 450 can be located proximal to a representation of the subsystem in the information panel 410. The information can be accessed by clicking on the interactive icon 450.

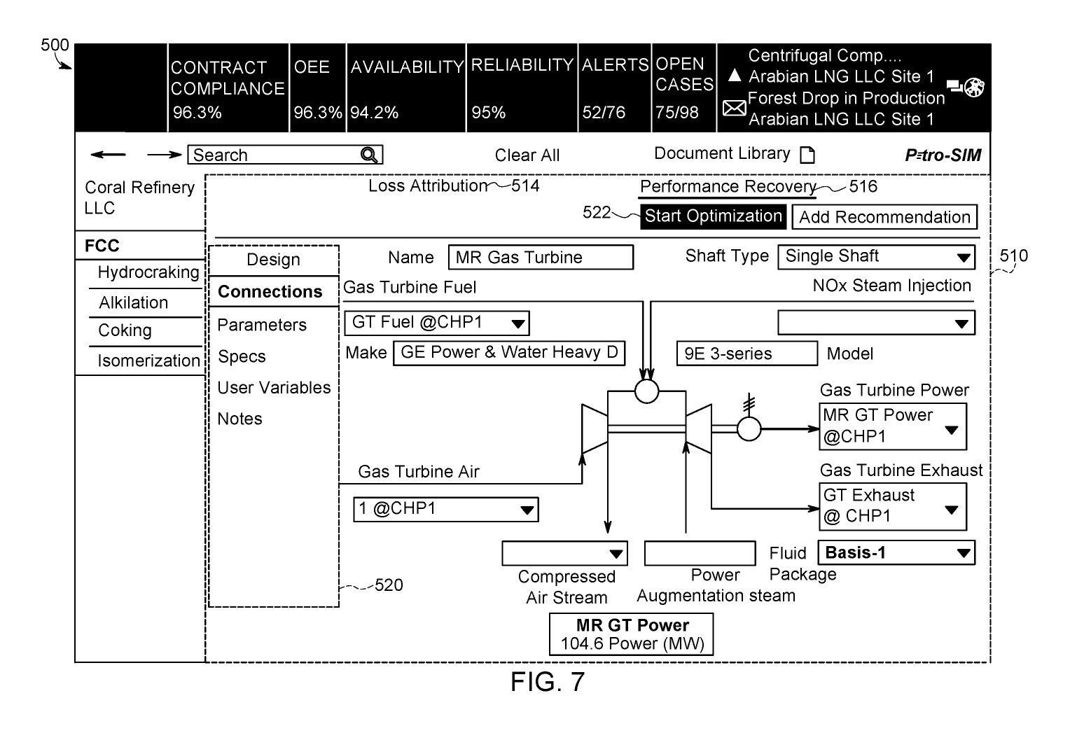

After accepting the connection, data characterizing a digital model of the plant, system, subsystem, or component, can be delivered from the process simulation module to the user device 114. As shown in FIG. 7, a view 500 of the GUI that shows a graphical representation of a digital model of a component of the subsystem (e.g., the refrigeration subsystem) can be rendered on the display of the user device 114. The GUI can show a graphical representation of the plant and/or a system, subsystem, or component of the plant. The GUI can include an information panel 510 that can be configured to provide the user with information related to the plant, system, subsystem, and/or component. The information panel 510 can also be configured to allow a user to generate a user defined recommendation to replace the blank card 426, shown in FIG. 5. In the illustrated view 500, the information panel 510 includes interactive buttons 514, 516 that can allow the user to view information related to loss attribution and performance recovery of the subsystem, respectively. The performance recovery button 516 is selected in FIG. 5. In the illustrated example, the information panel 510 shows a gas turbine that can be used to power a compressor of the refrigeration system, shown the information panel 410 in FIG. 5.

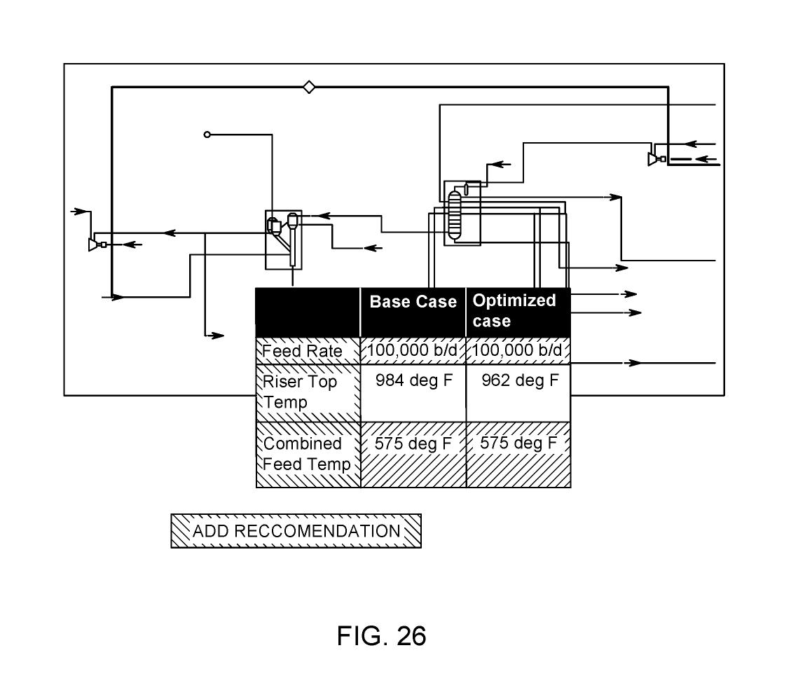

The information panel 510 can include a design panel 520 that can include buttons, or tabs, that can allow the user to navigate through a number of design considerations. The information panel 510 can also include a number of dropdown menus, text boxes, buttons, tabs, sliders, etc., that can allow the user to adjust various components, connections, parameters, operating specifications, and other variable associated with the component, to generate the user defined recommendation. The user can then run an analysis of the LNG plant 102, the system, subsystem, or the component based on inputs that the user provided on the information panel 510. For example, the user can start the analysis by interacting with a button 522 on the information panel. The user device can deliver data characterizing the user inputs to the analysis module 110 via the dashboard 112, and the analysis module 110 can process the data using the plant. For example, the analysis module 110 can incorporate data characterizing the user inputs into a digital model of the LNG plant 102 to calculate estimated operational data, i.e. data characterizing estimated performance of the LNG plant 102 and/or systems, subsystems, or components, of the LNG plant 102. FIG. 26 shows a portion of a view of a GUI that can be utilized for oil refineries. The GUI can be generated by clicking on the blank card in FIG. 25. The GUI can be a visual representation of a diagnostic/optimization model (e.g., Petro-Sim model). The view can include a block diagram of a portion of an oil refinery. The user can click on a graphical object (e.g., an Optimizer icon) to start the diagnostic/optimization process. This process can generate recommendations for the oil refinery (e.g., portion of the oil refinery illustrated in FIG. 26). The user can save the generated recommendation in a database of recommendations (e.g., by clicking on the “Add Recommendation icon”).

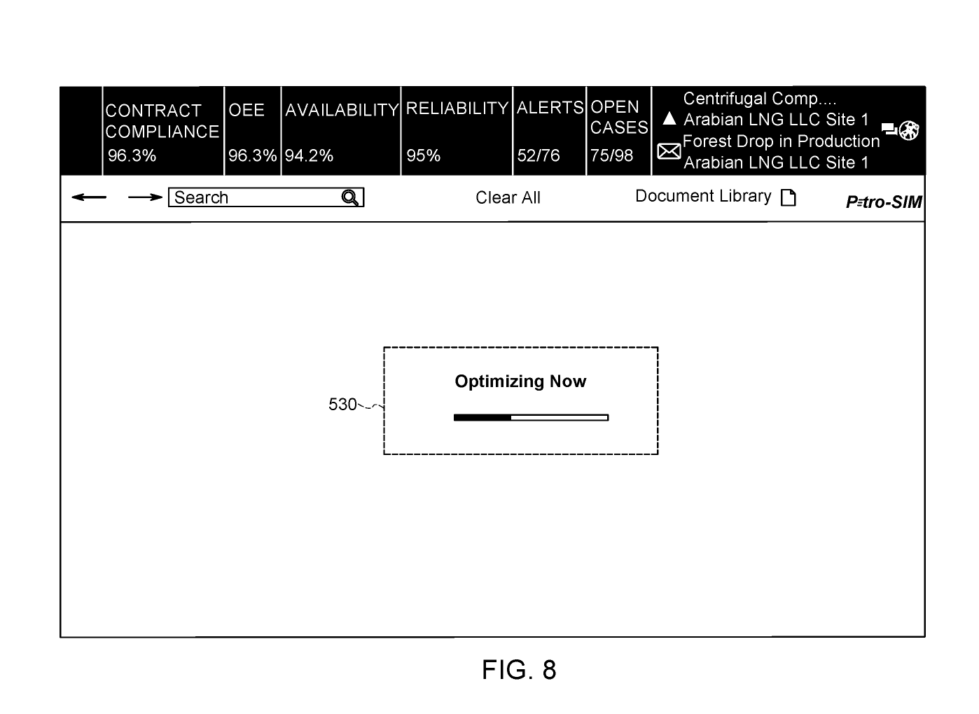

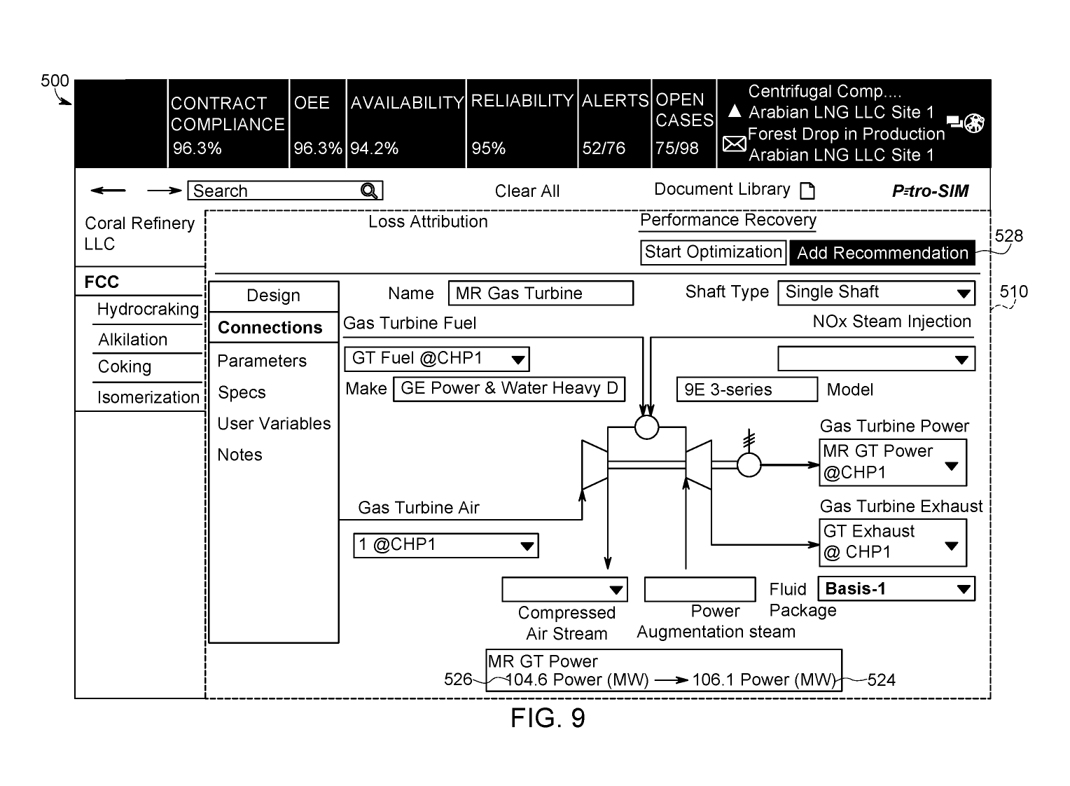

Referring to FIG. 8, as the analysis is performed, the GUI can show window 530 that illustrates a progress bar characterizing progress of the analysis. The analysis module 110 can provide the estimated operational data, including data characterizing estimated production loss, forecasts of production output, and predictions of future breakdowns, and actionable insights, to the dashboard 112. The dashboard 112 can receive the estimated operational data, format the estimated operational data, and create instructions that the user device 114 can use to render a graphical user interface that can provide the user with some, or all, of the operational data, as desired. The dashboard 112 can then deliver the formatted estimated operational data and the instructions to the user device 114. As shown in FIG. 9, the view 500 of the GUI can be updated to show certain estimate operational data 524, as well as original operational data 526, of the illustrated component. The user can also add the recommendation to the view 400, thereby replacing the blank card 426, by interacting with a button 528 on the information panel 510.

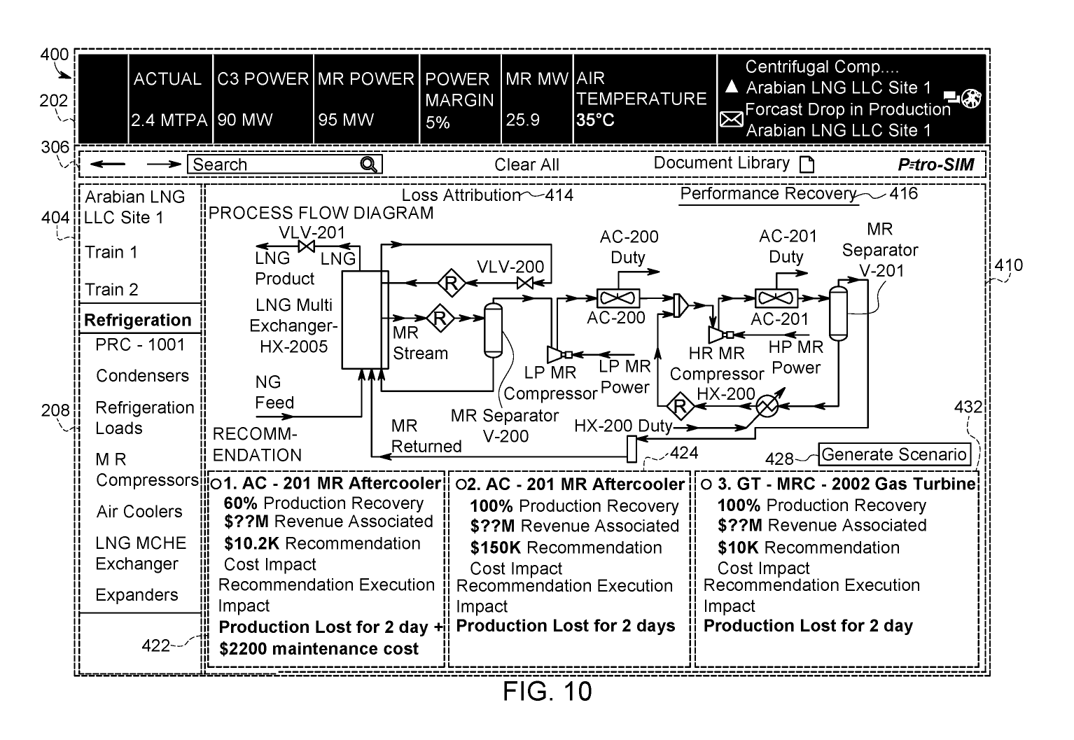

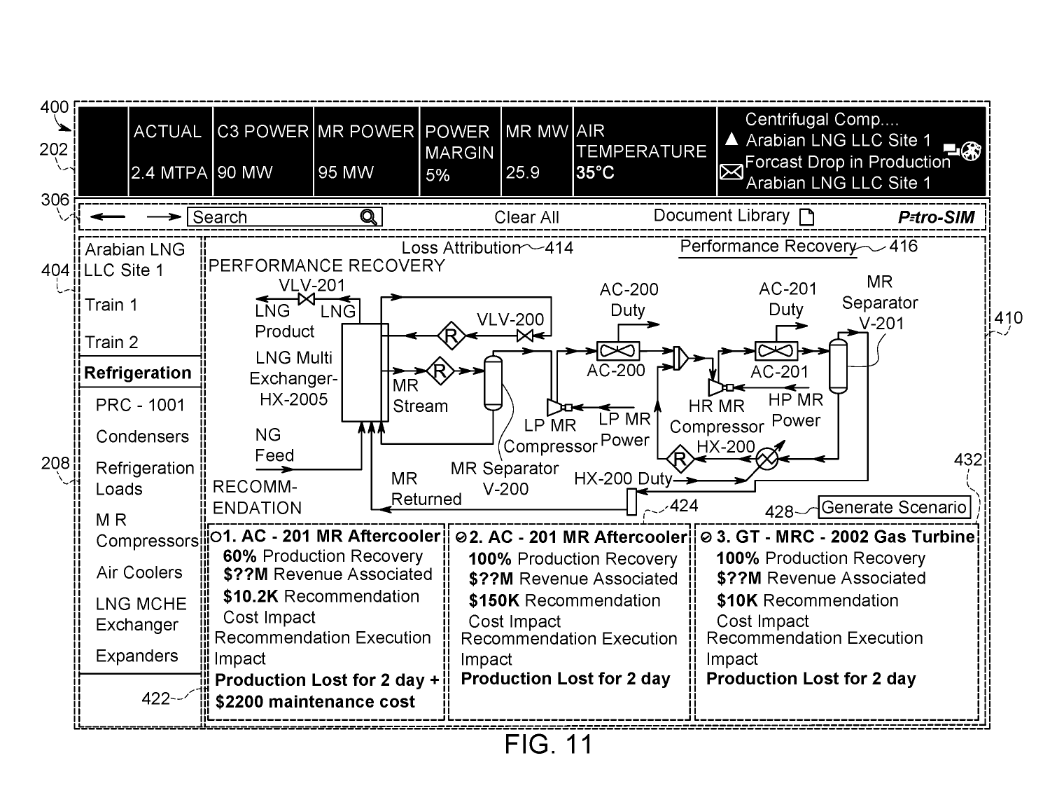

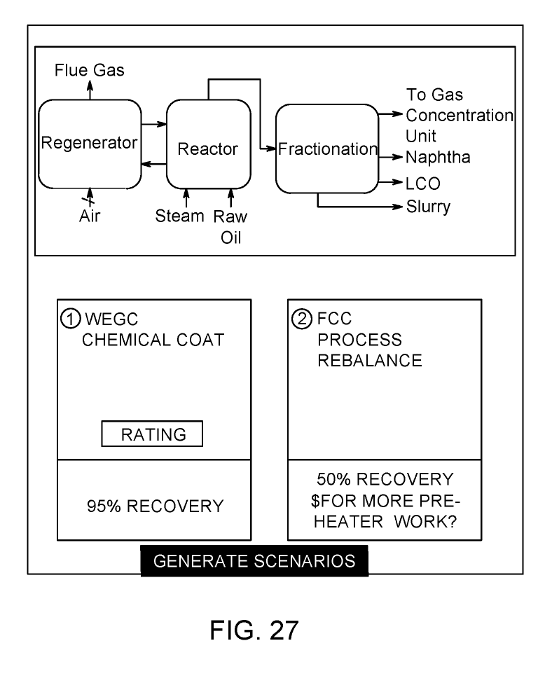

As shown in FIG. 10, the view 400 can be updated to include a card 432 that includes the user defined recommendation. The user can select one or more of the cards 422, 424, 432 to generate production forecasts for each of the selected recommendations. FIG. 11 shows the view 400 of the GUI with two cards 424, 432 selected. The user can then generate the scenario using the button 428 on the information panel 410. To generate the production forecasts, data characterizing the recommendations on the selected cards 424, 432 can be delivered to the analysis module 110 via the dashboard 112. The analysis module 110 can incorporate data characterizing the user inputs into a digital model of the LNG plant 102 to calculate estimated operational data, i.e. data characterizing estimated performance of the LNG plant 102 and/or systems, subsystems, or components, of the LNG plant 102. The analysis module 110 can provide the estimated operational data, including data characterizing estimated production loss, forecasts of production output, and predictions of future breakdowns, and actionable insights, to the dashboard 112. The dashboard 112 can receive the estimated operational data, format the estimated operational data, and create instructions that the user device 114 can use to render a graphical user interface that can provide the user with some, or all, of the operational data, as desired. The dashboard 112 can then deliver the formatted estimated operational data and the instructions to the user device 114. FIG. 27 shows a portion of a view of a GUI that can be utilized for oil refineries. The portion of the view shows an information panel that can include features similar to those discussed above with respect to information panel 410 shown in FIGS. 10 and 11. For example, FIG. 27 can include a graphical object that represents recommendations generated by diagnostic/optimization model as discussed above with respect to FIG. 26. The graphical object can also include predicted information (e.g., production recovery, revenue, recommendation cost impact, recommendation execution impact, etc.) associated with the generated recommendation.

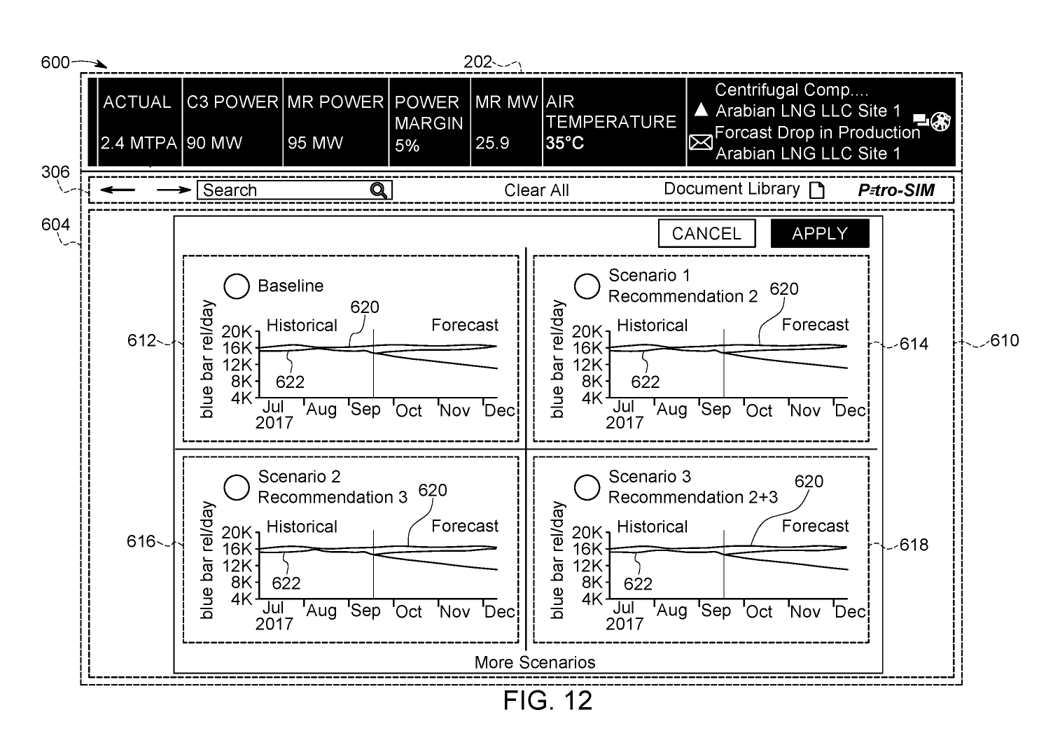

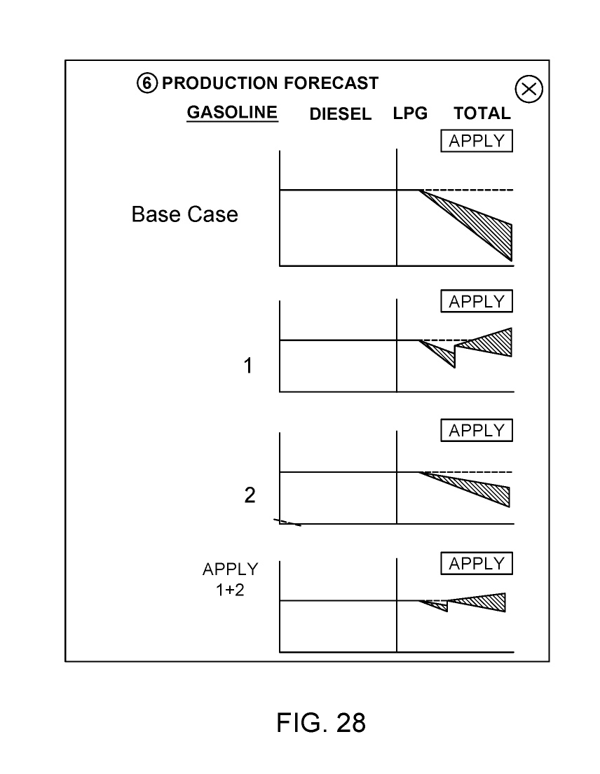

Referring to FIGS. 10-12, the user device 114 can receive the formatted estimated operational data and can render a view 600 of the GUI that shows forecasted production corresponding to the selected recommendations, as shown in FIG. 12. In the illustrated view 600, the GUI includes the status bar 202 and a data window 604 that includes the search panel 306, the menu panel 208, and an information panel 610. The information panel 610 can include cards 612, 614, 616, 618 that include plots of forecasted production. The card 612, 614, 616, 618 can include a baseline scenario that represents forecasted production if no action is taken, a first scenario that illustrates forecasted production if the recommendation on the first selected card 424 is applied, a second scenario that illustrates forecasted production if the recommendation on the second selected card 432 is applied, and a third scenario that illustrates forecasted production if the recommendations on both selected cards 424, 432 are applied, respectively. Each plot can include data illustrating a target production value 620, and a design production value 622. Although three cards 422, 424, 432 are shown in FIGS. 10 and 11, the view can include any number of recommendations. The user can select any number of the recommendations, in any combination, and generate any number of new recommendations, as described above. FIG. 28 shows an example of plots of forecasted production for an oil refinery. The plots can be shown in an information panel of a view can include features similar to those discussed above with respect to view 600 shown in FIG. 12. In some implementations, multiple forecast scenarios can be provided. For example, a first forecast scenario (“base case”) can predict an operation (e.g., gasoline production) if the current operation remains unchanged. A second and a third forecast scenario can be provided based on a first and a second recommendation selected/generated by the user. A fourth scenario can be provided that can be based on a combination of the first and the second recommendations. A user can implement the recommendation associated with a forecast scenario by clicking on a graphical object (e.g., “Apply” icon).

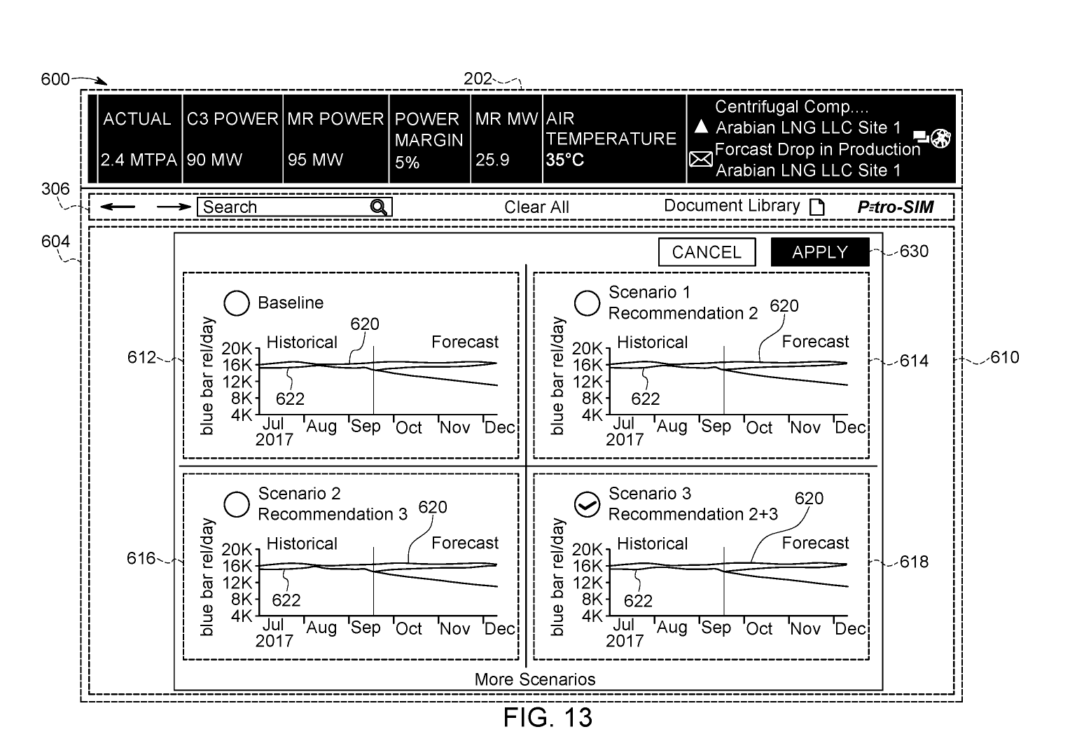

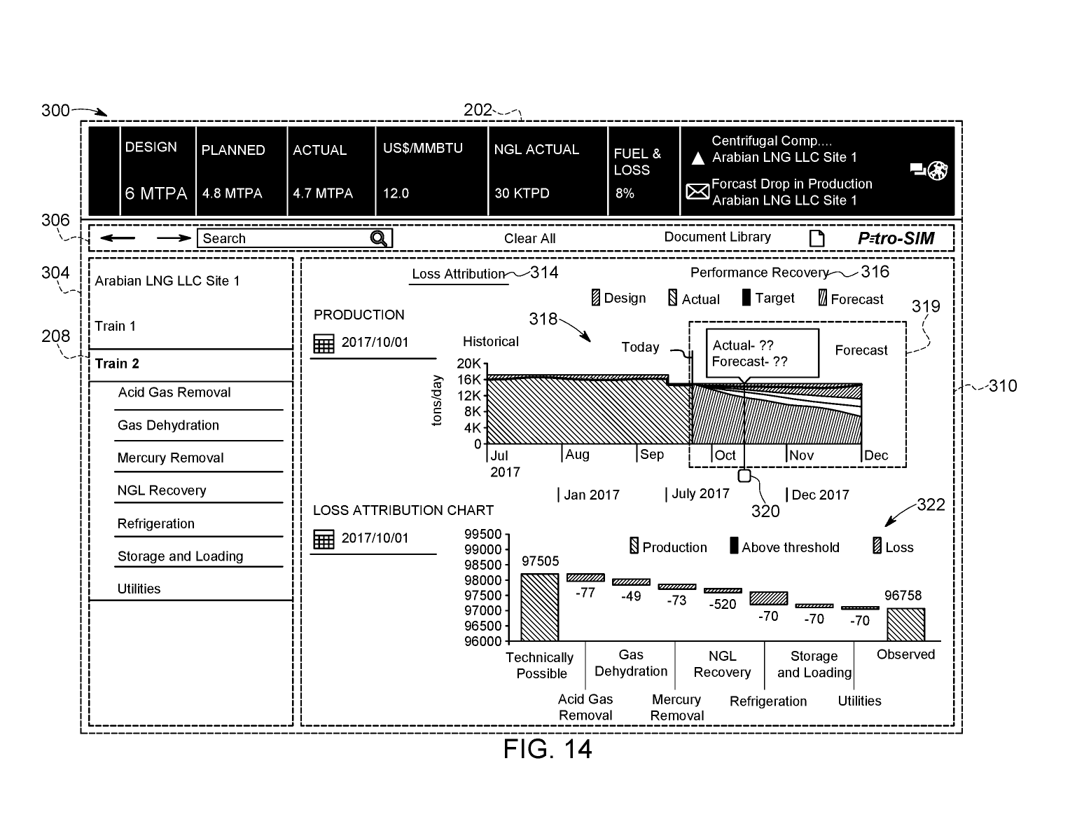

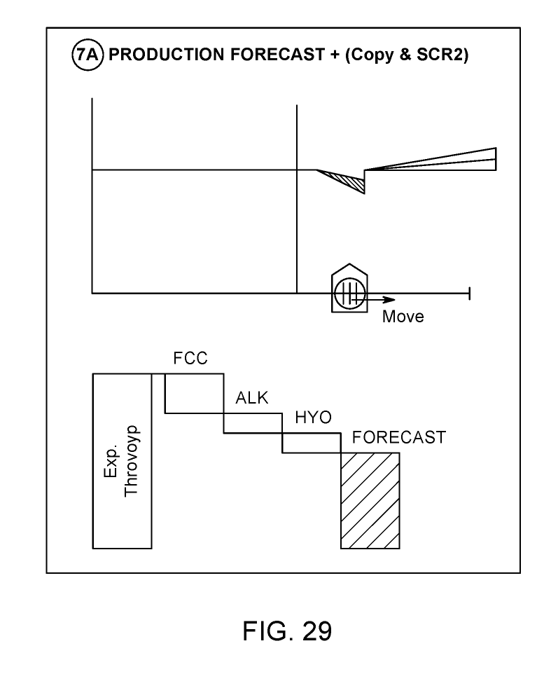

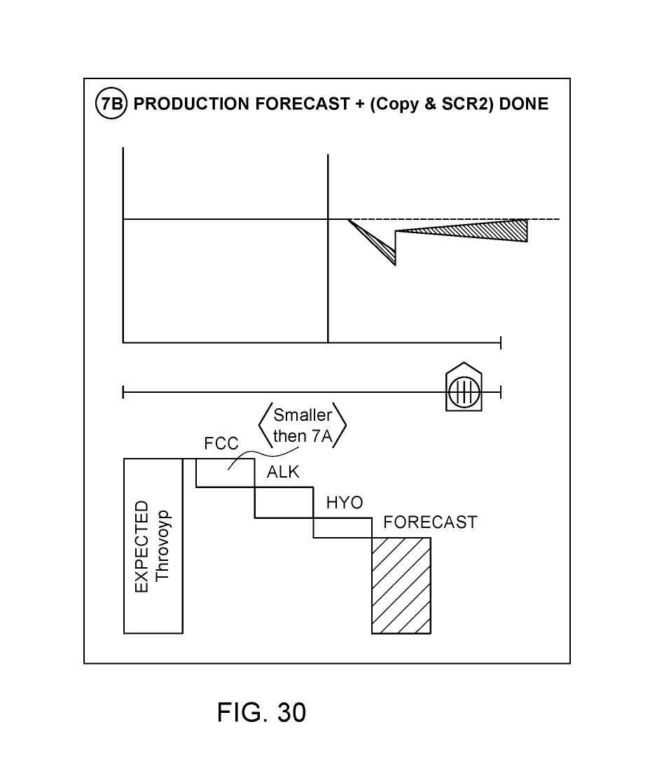

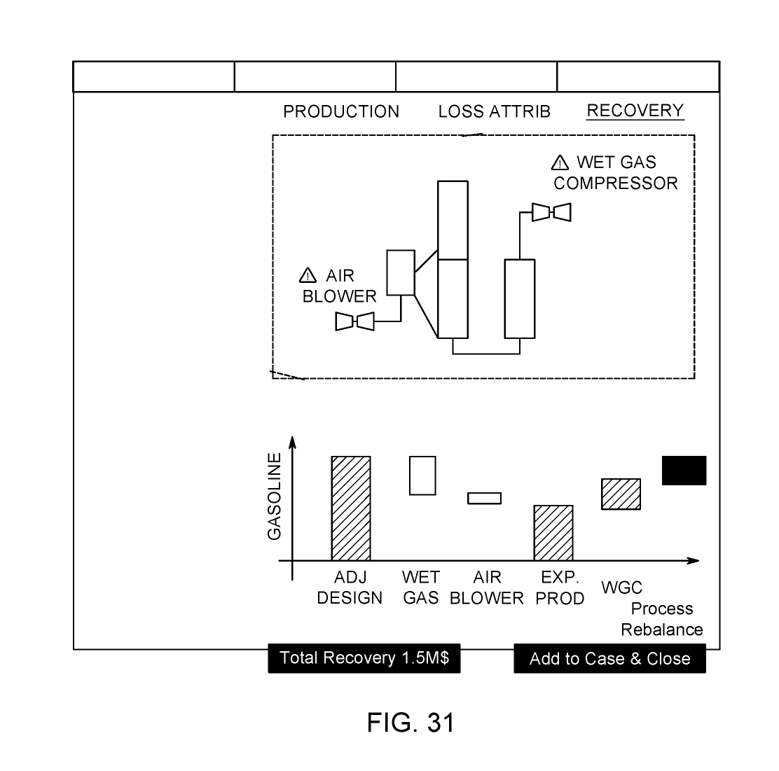

Referring to FIG. 12, one of the scenarios can be selected and applied using a button 630 on the information panel 610. FIG. 13 illustrates an example of the view 600 in which the third scenario has been selected. Once the selected scenario has been applied, the forecasting section 319 of the plot 318 in the view 300 can be updated, as illustrated in FIG. 14. Similarly, scenarios corresponding to the plots, shown in FIG. 28, corresponding to oil refineries, can be selected. The view 700 for an oil refinery, shown in FIG. 15, can updated to show forecasted production, as shown in FIGS. 29 and 30. FIGS. 29 and 30 can include a slider that can be moved (e.g., by clicking and dragging) to change the time period of forecast. Based on the forecast, a user can prepare recommendations (e.g., recommendations to be presented in the future). Additionally, the forecast of a plant can be broken down into multiple sub-forecasts associated with the various components/systems of the plant. FIG. 31 shows a view of the GUI that can be used for oil refineries. In this case, the view shows production, loss attribution, and recovery buttons. With the recovery button selected, the view shows a block diagram of a subsystem of the oil refinery, with an updated loss attribution chart showing recovered production based on the selected scenario.

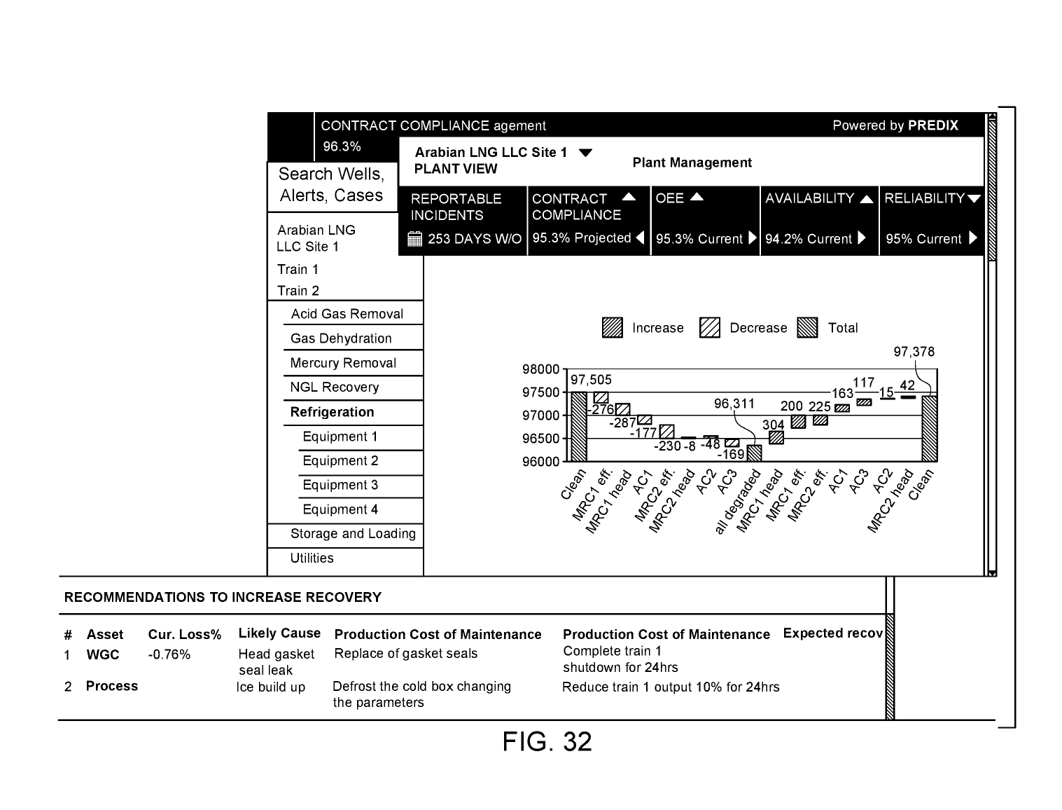

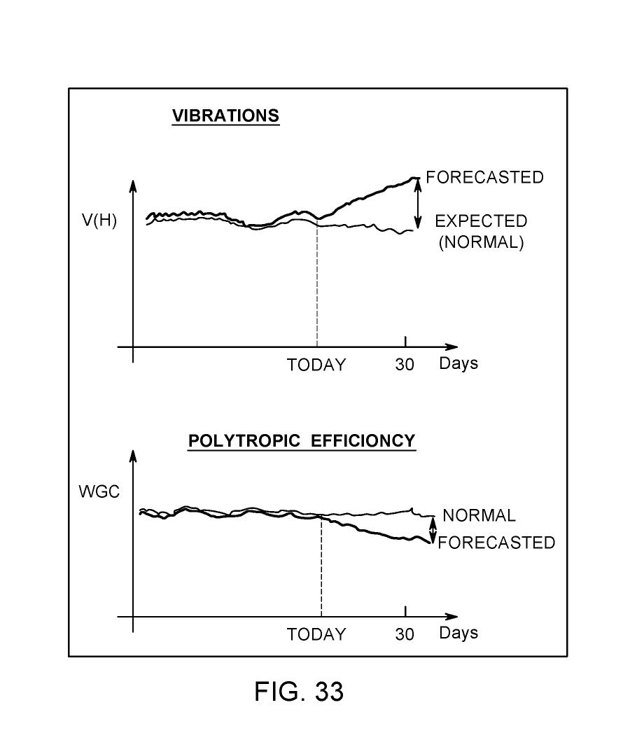

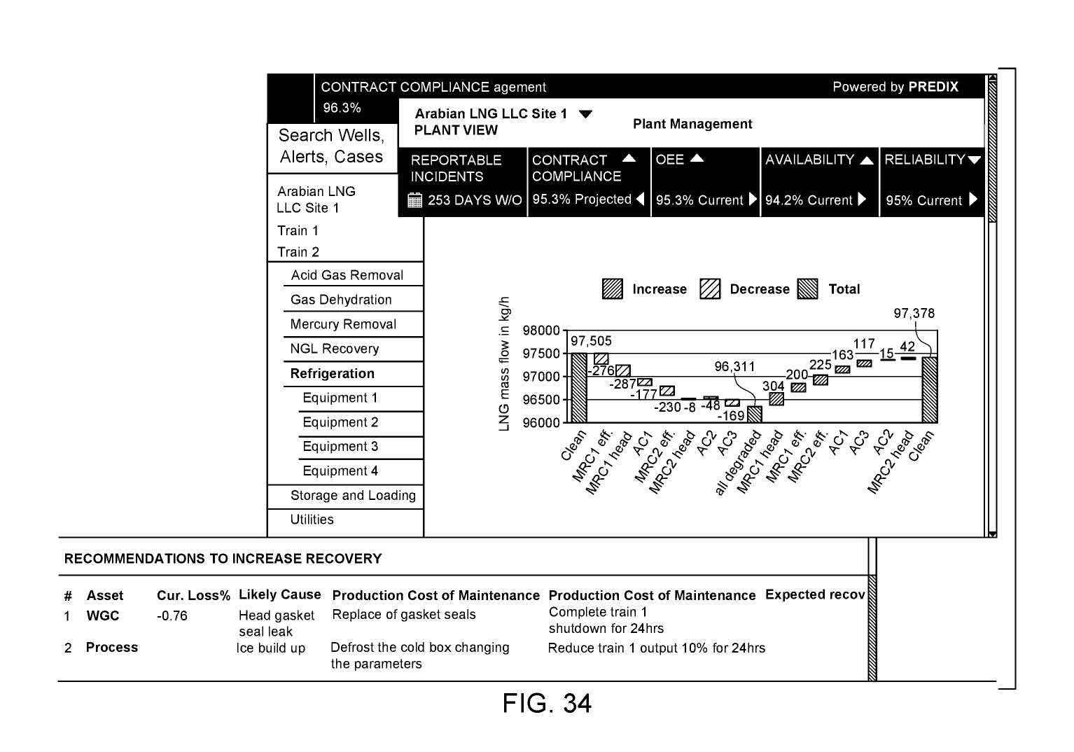

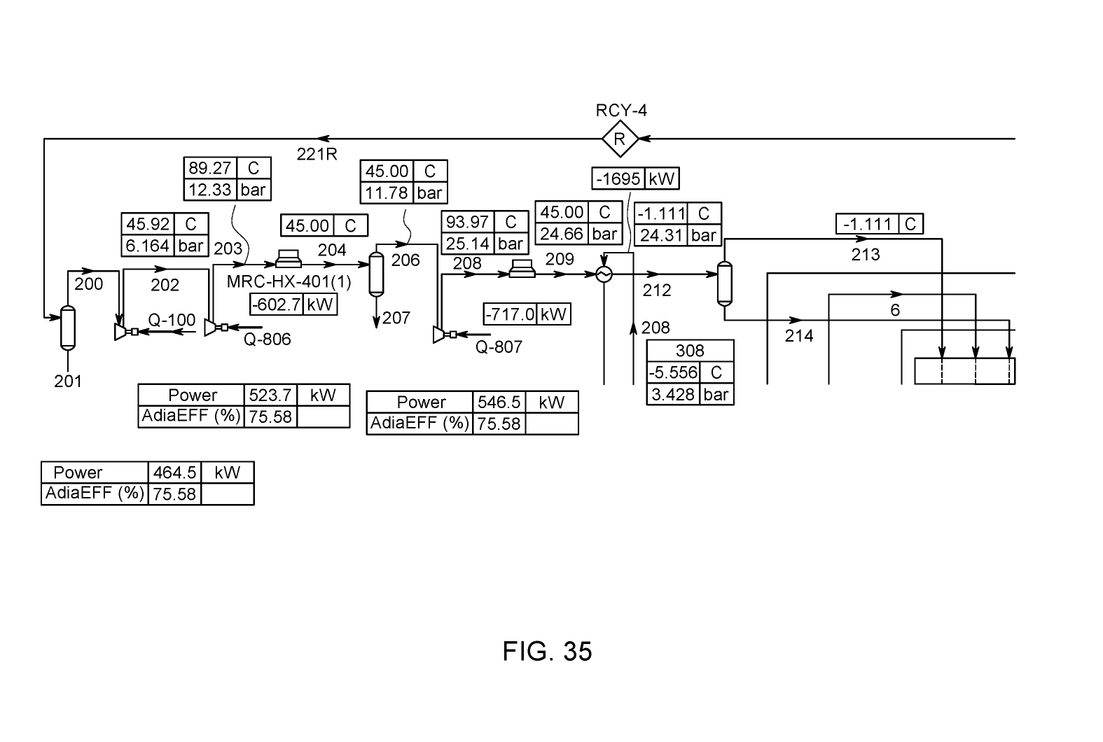

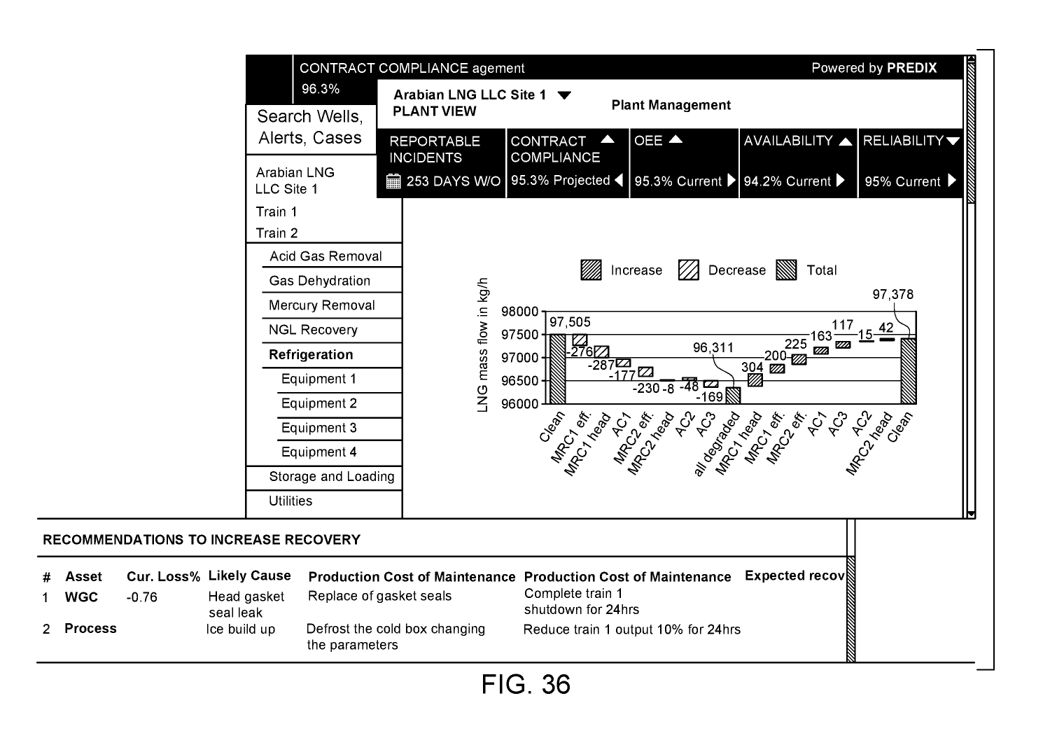

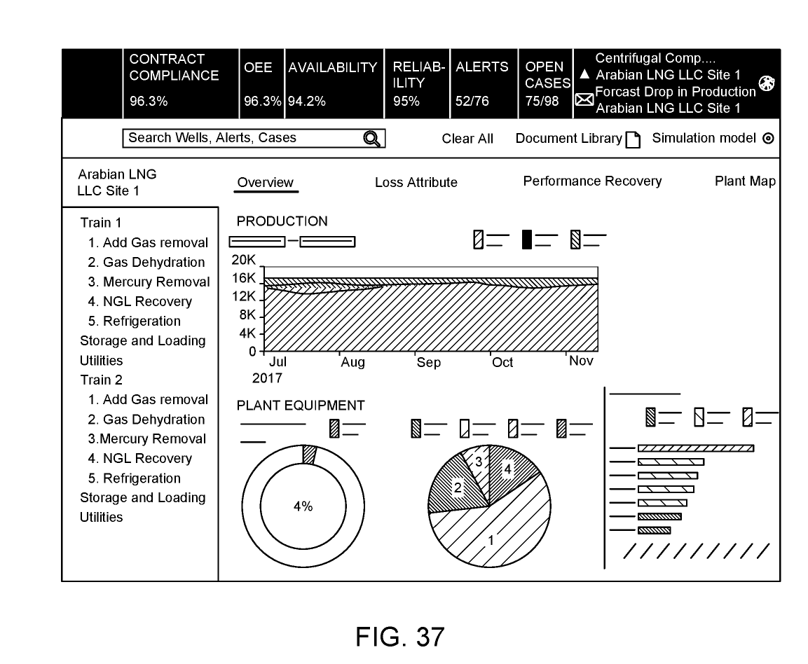

FIG. 32 shows another view of a GUI that can be used for oil refineries. In this case, a recovery waterfall chart is shown in an information window. The recovery waterfall chart can show recovered production for various system, subsystems, and components of the oil refinery based on a selected scenario, as described above. For example, the recovery waterfall chart can indicate that a component (e.g., Wet Gas Compressor) is the biggest contributor to production losses. A user can request more information on the performance of the component (e.g., production losses associated with the component). The user can also select other recommendations corresponding to subsystems or components (e.g. the WGC). Another view, or window, can be shown to illustrate forecasted production and/or efficiency of the subsystem and/or component, as shown in FIG. 33. For example, a plot of previous and/or forecasted parameter (e.g., efficiency, vibration, etc.) versus time can be presented. The user can navigate back to the view shown in FIG. 26-27, and can select another recommended scenario. The user can view a corresponding recovery waterfall, as shown in FIG. 34, and can open a view that shows a block diagram of the system, and shown in FIG. 35. The blocks in the block diagram can be representative of a component (e.g., Wet Gas compressor). The blocks can be interactive (e.g., a user can adjust operating parameters of a component represented by a block to increase production of the component). The user can adjust certain connections, parameters, specifications, and/or user variables, and can process the input data to generate a new performance recovery waterfall chart, as shown in FIG. 36. The user can also navigate to overview view to see forecasted production, revenue gained from avoiding lost production, and other information related to the oil refinery, as shown in FIG. 37.

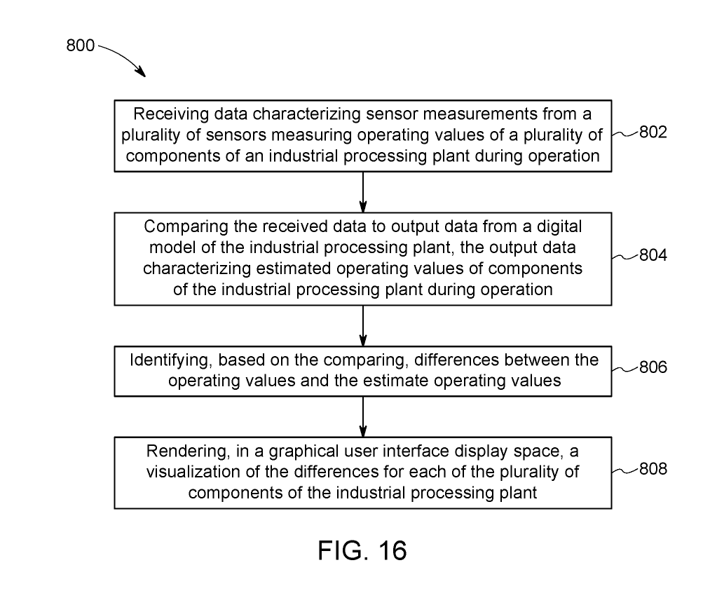

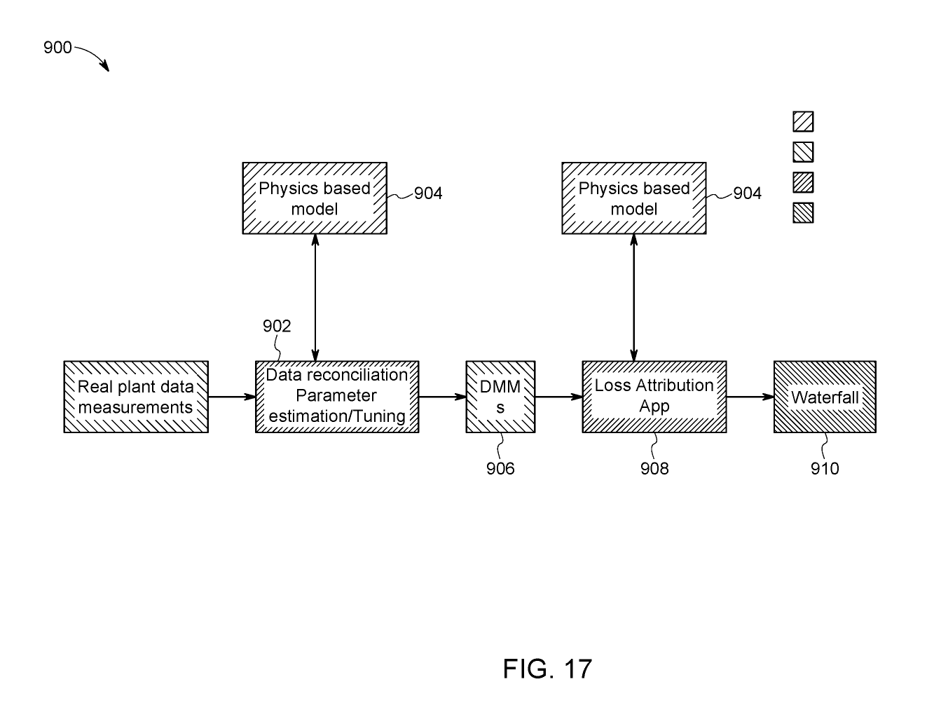

FIG. 16 illustrates a flow chart of an exemplary method 800 for providing a user with production loss data of an industrial plant. As shown at step 802 in FIG. 16, the method 700 can include receiving data characterizing sensor measurements from a plurality of sensor measuring operating values of a plurality of components of the industrial processing plant during operation. FIG. 17 shows a block diagram 900 that illustrates communication between sensors (e.g., sensors 106), an advisory system (e.g., advisory system 100), and a user device (e.g. user device 114), to provide production loss data. As an example, a data reconciliation subsystem 902 can receive sensor data from the sensors 106 coupled to the components 104 of the LNG plant 102. The reconciliation subsystem 902 can also receive model data characterizing a digital model, or process simulation model (e.g., physics based model), of the LNG plant 102 from a process simulation module 904. The reconciliation subsystem 902 can process the model data to minimize error between sensor data (e.g. measure data) and model-predicted data.

At step 804, the received data (e.g. the sensor data) can be compared to the output data from the digital model of the industrial processing plant (e.g., the LNG plant 102). As described above, the output data can characterize estimated operating values of components of the industrial processing plant during operation. For example, the reconciliation subsystem 902 can compare the sensor data to the model data. At step 806, the differences between the operating values and the estimated operating values can be identified based on the comparison. As an example, the reconciliation subsystem 902 can compare the sensor data to the output data from the digital model. The reconciliation subsystem 902 can also identify differences between the operating values and the estimated operating values based on the comparison. For example, the reconciliation subsystem 902 can use analytics to create data arrays that reconcile the differences between the sensor data and the model data. The differences can correspond to production loss data. The data arrays can characterize key process and equipment parameters such as efficiency, exchanger effectiveness, pipe friction coefficient, compressor efficiency, etc. The reconciliation subsystem 902 can then generate data matching multipliers (DMMs) 906 which can be, or can characterize, the data arrays that represent the difference between the sensor data and the model data.

The DMMs 906 can characterize equipment efficiency, e.g., exchanger effectiveness, pipe friction, coefficient, compressor efficiency, etc. The reconciliation subsystem 902 can deliver the DMMs and the sensor data to a loss attribution subsystem 908. The loss attribution subsystem 908 can also receive model data from process simulation module 904. The model data can include data characterizing each component of the LNG plant 102. The loss attribution subsystem 908 can process the model data in conjunction with the sensor data to generate output data that characterizes estimated operating values of components of the LNG plant 102. For example, the loss attribution subsystem 908 can apply the DMMs 906 and the model data within a loss attribution algorithm to determine the non-recoverable and recoverable production losses, and attribute the recoverable losses to the various systems, subsystems, and/or components of the industrial plant (e.g., the LNG plant 102).

In some embodiments, the reconciliation subsystem 902, loss attribution subsystem 908, and the process simulation module 904 can be part of an analysis module (e.g., analysis module 110). In other embodiments, the reconciliation subsystem 902 and the loss attribution subsystem 908 can be part of an analysis module, and the process simulation module 904 can be part of another system, or subsystem. At step 808, a visualization of the differences for each of the plurality of components of the industrial processing plant can be rendered in a graphical user interface display space. As an example, operational data, including data characterizing production loss (e.g., waterfall data 910), forecasts of production output, and predictions of future breakdowns, and actionable insights, can be delivered to a user device (e.g. user device 114) via a dashboard (e.g., dashboard 112), as described above. The user device can also receive instructions for rendering various views of a GUI to display the operational data. In some embodiments the differences (e.g. production loss) can be visualized using a waterfall chart such as the waterfall chart 322 shown in FIGS. 4 and 14. In some instances, the loss attribution subsystem 908 can provide updated production loss data every 15 minutes based on a status of the plant.

In some embodiments, the loss attribution subsystem 908 can call the process simulation module 904 to receive model data corresponding to individual components or subsystems of the plant. The loss attribution subsystem 908 can process the model data in conjunction with the sensor data generate output data that characterizes estimated operating values of components of the LNG plant 102, and can compare the sensor data to the output data from the digital model component. The loss attribution subsystem 908 can also identify differences between the operating values and the estimated operating values based on the comparison. The process can be repeated for each component of the plant to generate production loss data for the plant.

As described above, an advisory system can provide a user with performance recovery information. For example, the advisory system can provide recommendations for recovering production of an industrial plant. The performance recovery information can include information regarding an amount or percentage of production that can be recovered if a recommended operation is performed, an amount of revenue associated with the recovered production, a cost impact associated with performing the operation, and an execution impact. The execution impact can include information characterizing an impact on production, as well as costs of parts and/or labor associated with performing the operation.

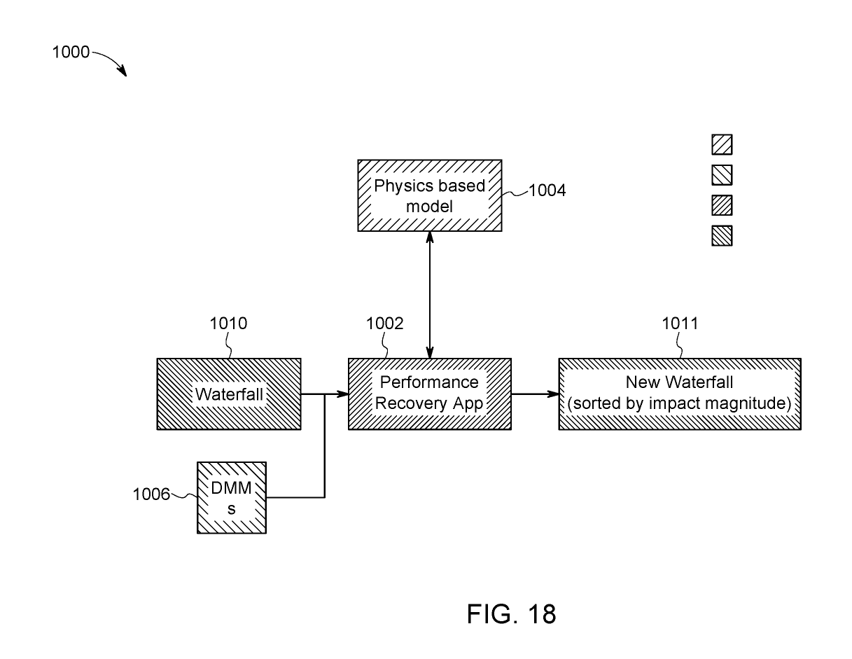

FIG. 18 shows a block diagram 1000 that illustrates data flow associated with providing a user with performance recovery information. In the illustrated example, a performance recovery subsystem 1002 can receive waterfall data 1010, and DMMs 1006. The performance recovery subsystem can also receive model data characterizing a digital model of an industrial plant (e.g., the LNG plant 102) from a process simulation module 1004. The performance recovery subsystem 1002 can use the waterfall data 1010, the DMMS 1006, and the model data within a performance recover analysis to generate new waterfall data 1011 that can be delivered to a user device (e.g., user device 114) to update a waterfall chart with performance recovery data. One purpose of the performance recovery analysis is to address the potential recovery from the main contributors (e.g. systems, subsystems, and/or components of the LNG plant 102) of performance loss. The performance recovery can be assessed by restoring systems, subsystems and/or components with the highest recoverable production loss first. The output from the loss attribution analysis (e.g., waterfall data 910) can be used as the input to the performance recovery analysis. The performance recovery analytics can use domain knowledge that can be programmed into the performance recovery module 1002 and the physics based model or models. The performance recovery module 1002 can generate new waterfall data 1011 that can be delivered to a user device (e.g., the user device 114) to be displayed in the form of a loss recovery waterfall chart and recommendations. The user can analyze what impact each recommendation has on recovering production and can also evaluate the impact of the recommendation from a health, safety, and environment (HSE) and financial perspective in order to make an informed decision. In some embodiments, the performance recovery subsystem can be part of an analysis module such as, e.g., the analysis module 110 described above with regard to FIG. 1.

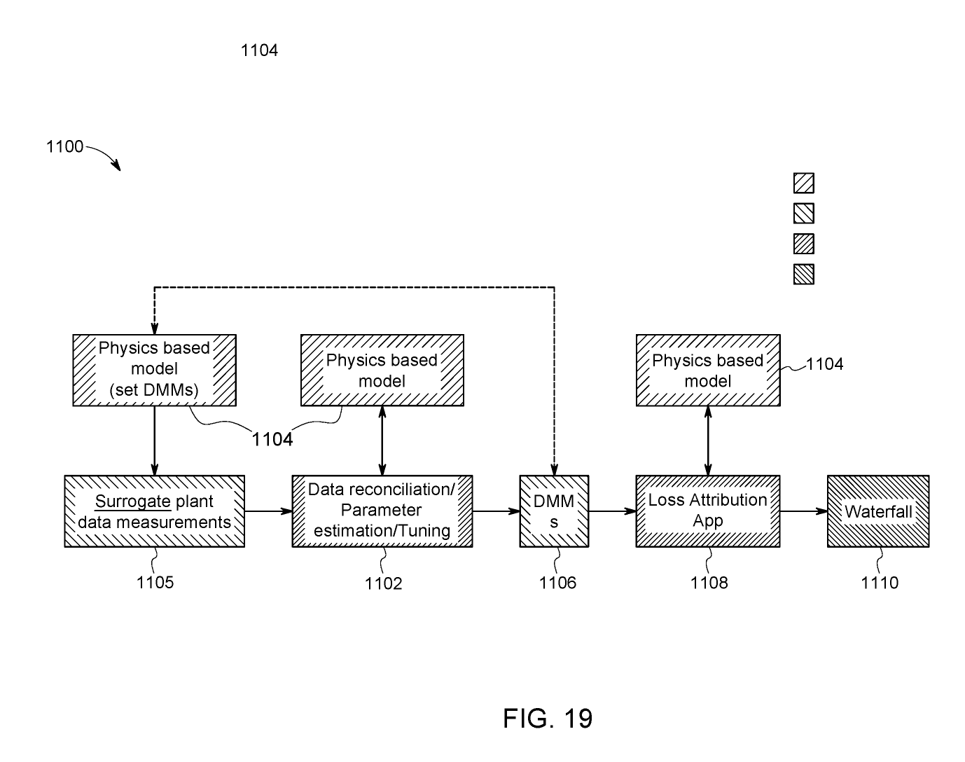

In some embodiments relevant sensor data from a plant (e.g., the LNG plant 102) may not be available. FIG. 19 shows a block diagram 1100 that illustrates communication between sensors (e.g., the sensors 106), an advisory system (e.g., the advisory system 100), and a user device (e.g. the device 114), to provide production loss data when relevant sensor data and/or corresponding physics based model are not available. In the illustrated embodiment, a process simulation module can generate surrogate sensor data 1105 as a replacement for actual sensor data. A data reconciliation subsystem 1102 can receive the surrogate sensor data 1105 as well as model data characterizing a digital model of the plant from the process simulation module 1104. The reconciliation subsystem 902 can process the model data to minimize error between sensor data (e.g. measure data) and model-predicted data. The reconciliation subsystem 902 can then generate data matching multipliers (DMMs) 1106. The DMMs 1106 can be compared to DMMs associated with the surrogate sensor data to verify that they are the same. If they are not the same, the process simulation module 1104 can adjust the DMMs to provide new surrogate sensor data 1105. The process can repeat until the DMMs 1106 match the DMMs corresponding to the surrogate sensor data 1005.

The data reconciliation subsystem 1102 can deliver the DMMs 1106 and the surrogate sensor data 1005 to a loss attribution subsystem 1008. The loss attribution subsystem 1008 can also receive model data from process simulation module 1104. The model data can include data characterizing each component of the plant. The loss attribution subsystem 1008 can process the model data in conjunction with the sensor data generate output data that characterizes estimated operating values of components of the loss attribution subsystem 1008. The loss attribution subsystem 1008 can compare the surrogate sensor data 1005 to the output data from the digital model. The loss attribution subsystem 1008 can also identify differences between the operating values and the estimated operating values based on the comparison. The differences can correspond to production loss data. The loss attribution subsystem 1008 can deliver the production loss data to a user device (e.g., the user device 114) via a dashboard (e.g., the dashboard 112), to generate a visualization of the production loss data in the form of a waterfall chart (e.g., the waterfall chart 322).

Some implementations of the current subject matter include an extension to an asset performance management system. Some implementations of the current subject matter can forecast production losses in an LNG plant, determine how much of the production losses are recoverable, and attribute the recoverable losses to the various systems that make up the plant. Once the system has attributed the recoverable losses it identifies the probable causes of the losses within each system so that it is able to make recommendations to the user on how to recover production. The user can then analyze the HSE and financial implications of the recommendations before proposing them for implementation.

Some implementations of the current subject matter can compare data generated by instruments on an operating LNG plant to the data calculated by one or more physics based models such as a process simulation model or digital model of an equipment item. Some implementations of the current subject matter can use analytics to create data arrays that reconcile the differences between the two sets of data. The data arrays can characterize key process and equipment parameters such as efficiency, exchanger effectiveness, pipe friction coefficient, compressor efficiency, etc.

The data arrays can then be fed into a loss attribution algorithm, which can use the physics based model or models to determine the non-recoverable and recoverable production losses, and then attribute the recoverable losses to the various sub-systems that make up the plant. Some implementations of the current subject matter can display the output in the form of a loss attribution waterfall chart. Loss attribution can include a methodology to assign the losses based on domain knowledge. The waterfall can be automatically updated every 15 minutes based on current plant status.

After the system has attributed the production losses, it can then run a performance recovery analysis. Some implementations of the current subject matter can address the potential recovery from the main contributors. The performance recovery can be assessed by restoring the sub-system with the highest recoverable production loss first. The output from the loss attribution analysis can be used as the input to the performance recovery analysis. The performance recovery analytics can use domain knowledge that is programmed into the software and the physics based model or models. The system can display the output in the form of a loss recovery waterfall chart and recommendations. The user can analyze what impact each recommendation has on recovering production and can also evaluate the impact of the recommendation from an HSE and financial perspective in order to make an informed decision.

Some implementations of the current subject matter can help operators and managers on an LNG plant to forecast the drop in production from the planned production due to process, equipment, and environmental reasons and to make informed, safe, and financially sound decisions on how to recover future production to planned levels by process adjustments and by predictive maintenance.

Some implementations of the current subject matter can forecast drop in production from planned levels using process and equipment health monitoring; attribute production losses at plant, train, sub-system and equipment levels; use domain knowledge to automatically generate recommendations on recovering production; evaluate recommendations against repair cost impact projections (cost of repair, parts and projected plant downtime) and HSE considerations; combine plant production forecasts with process optimization models; provide a user interface with tiled forecast recommendations that can be combined and run through a process simulation model to create various detailed production forecast scenarios, which can allow users to pick a strategy that maximizes profit, balancing the cost of raw materials, equipment wear and profit from final product, while at the same time considering the HSE implications; force-rank recommendations of specific scenarios to the user based on HSE impact, overall cost and asset life optimization; and the like.

The current subject matter can include the ability to import plant data and reconcile against the output from a process simulation model; the ability to develop analytics that use domain knowledge to attribute forecast production losses to sub-systems within the plant; the ability to develop analytics that use domain knowledge to generate recommendations to recover production; and/or a knowledge management system incorporating machine learning to continuously improve forecasting of production losses, continuously improve attribution of production losses, continuously improve recovery recommendations based on previous ones.

Exemplary technical effects of the subject matter described herein include, the ability to forecast drop in production from planned levels using process and equipment health monitoring, attribute production losses at plant, train, sub-system and equipment levels, use domain knowledge to automatically generate recommendations on recovering production, evaluate recommendations against repair cost impact projections (cost of repair, parts and projected plant downtime) and HSE considerations, combine plant production forecasts with process optimization models. Moreover, the current subject matter provides a user interface and/or user experience approach that utilizes tiled forecast recommendations (e.g., the cards 422, 424, and 432 shown in FIG. 10) that can be combined and run through a process simulation model to create various detailed production forecast scenarios. Such an approach can allow users to pick the best strategy that maximizes profit, balancing the cost of raw materials, equipment wear and profit from final product, while at the same time considering the HSE implications. Another exemplary technical effect of the subject matter describe herein includes the ability of the system to force-rank recommendations of specific scenarios to the user based on HSE impact, overall cost and asset life optimization. Another exemplary technical effect of the current subject matter is that it allows operators and managers of an industrial facilities to forecast the drop in production from the planned production due to process, equipment, and environmental reasons and to make informed, safe, and financially sound decisions on how to recover future production to planned levels by process adjustments and by predictive maintenance.

In some implementations, the process simulation model can include one or more system coefficients (e.g., predetermined coefficients related to the asset and/or sensors associated with the asset). Updating the simulation model can include determining new system coefficients and replacing the coefficients of the simulation model with the newly determined coefficients. In some implementations, the new system coefficients can be determined based on data characterizing a property of the asset over a time period (e.g., a property/operating parameter of the asset detected by a sensor coupled to the asset) and/or data characterizing user interaction with an interactive graphical object in the GUI (e.g., blank card 426).

This the current subject matter can be applied to any processing facility within the upstream, midstream and downstream sectors industrial processing plants. For example, the current subject matter can be applied in offshore platforms and FPSO's, onshore oil and/or gas production facilities, gathering centers, pipelines, refineries, and/or petrochemical plants. The current subject matter can be applied to any continuously operating processing facility in any industry where there is a desire to forecast production losses and implement strategies to recover production. For example, the current subject matter can be applied within power stations (e.g., oil, gas, coal, nuclear), water treatment facilities, and food and beverage facilities. The current subject matter can also be applied for consumer products and pharmaceuticals.

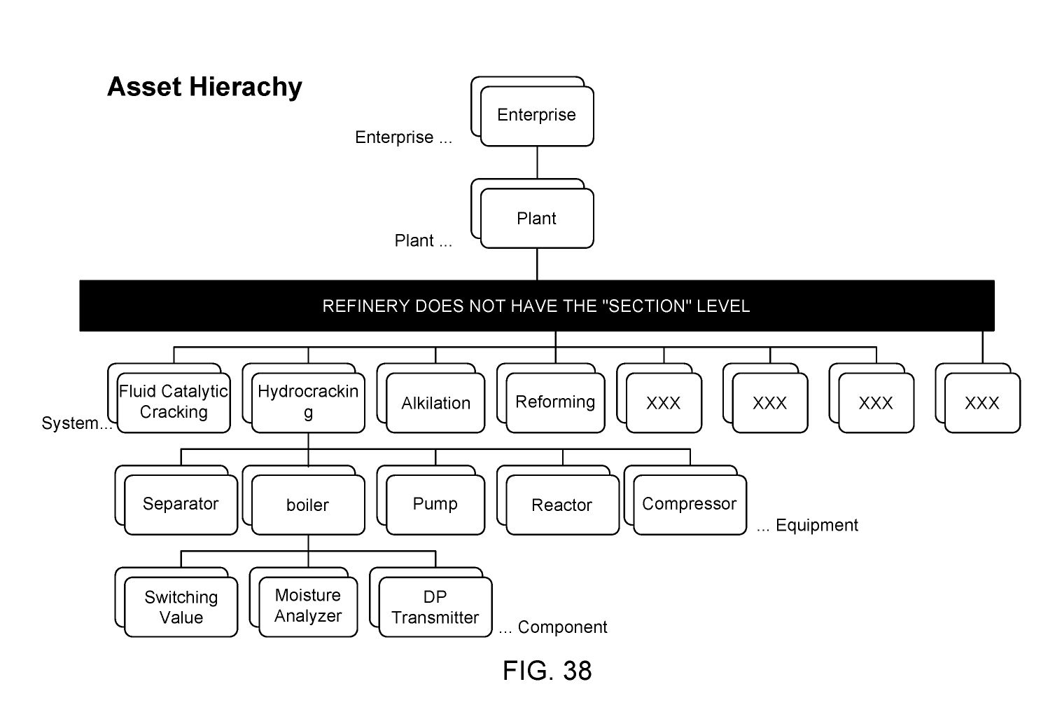

FIG. 38 is a schematic illustration of an exemplary hierarchy of an asset. An asset can include multiple systems (e.g., fluid catalytic cracking system, hydrocracking system, alkylation system, etc.). A system can include multiple equipment (e.g., separator, pump, boiler, pump, reactor, etc.). An equipment can include multiple components (e.g., switching valve, moisture analyzer, DP transmitter, etc.). Implementations of advisory system described above, can be configured to monitor the entire asset or a portion of the asset (e.g., one or more systems in the asset, one or more equipment in a system, etc.).

One skilled in the art will appreciate further features and advantages of the subject matter described herein based on the above-described embodiments. Accordingly, the present application is not to be limited specifically by what has been particularly shown and described. All publications and references cited herein are expressly incorporated herein by reference in their entirety.

Other embodiments are within the scope and spirit of the disclosed subject matter.

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
rendering, in a graphical user interface display space, a first interactive graphical object characterizing a first input value indicative of a first oil and gas machine of a plurality of oil and gas industrial machines;
receiving data characterizing user interaction with the first interactive graphical object and indicative of the first input value;
determining, by a predictive model, data characterizing a characteristic property of a plurality of components of the first oil and gas machine over a first time period, the determining based in part on data characterizing one or more operating parameters of the plurality of components over a second time period; and
rendering, in the graphical user interface display space, a first plot of the determined data characterizing the characteristic property over the first time period and a second plot of data characterizing the characteristic property over the second time period.

2. The method of claim 1, further comprising determining the data characterizing the characteristic property over the second time period from the data characterizing one or more operating parameters of the plurality of components of the first oil and gas machine.

3. The method of claim 2, further comprising:
generating, by the predictive model, a plurality of recommendations for the first oil and gas machine, the plurality of recommendations indicative of a plurality of predicted outputs of the plurality of components of the first oil and gas machine;
rendering, in the graphical user interface display space, one or more interactive graphical objects representative of one or more of the plurality of predicted outputs; and
receiving, from a user, data characterizing selection of one or more of the plurality of predicted outputs by the user.

4. The method of claim 3, further comprising:
generating, by the predictive model:
a first forecast of the characteristic property of the plurality of components over the first time period, the first forecast based on selection of a first predicted output of the plurality of predicted outputs and indicative of a first plurality of future values of the characteristic property, and
a second forecast of the characteristic property of the plurality of components over the first time period, the second forecast based on selection of a second predicted output of the plurality of predicted outputs and indicative of a second plurality of future values of the characteristic property;
rendering, in the graphical user interface display space, a first forecast plot of the first forecast of the characteristic property over the first time period, and a second forecast plot of the second forecast of the characteristic property over the first time period.

5. The method of claim 4, further comprising generating, by the predictive model, a third forecast of the characteristic property of the plurality of components over the first time period, the third forecast based on selection of the first predicted output and the second predicted output.

6. The method of claim 4, wherein the first forecast of the characteristic property of the plurality of components over the first time period is determined by the predictive model based on the one or more operating parameters of the plurality of components over the second time period and an input recommendation for the first oil and gas machine provided by the user.

7. The method of claim 6, further comprising updating the predictive model, the updating comprising determining one or more system coefficients associated with the plurality of components of the first oil and gas machines.

8. The method of claim 7, wherein the predictive model is configured to calculate the one or more system coefficients based on a characteristic mathematical representation of the plurality of components of the first oil and gas industrial machine, the characteristic mathematical representation includes a system of equations that calculate the one or more system coefficients based, at least in part, on data characterizing a user input.

9. The method of claim 1, wherein the characteristic property is indicative of performance of the plurality of components over the first time period.

10. The method of claim 1, further comprising receiving the data characterizing one or more operating parameters of the plurality of components of the first oil and gas machine, wherein the data characterizing one or more operating parameters is detected by one or more sensors coupled to the first oil and gas machine.

11. The method of claim 1, further comprising, rendering in the graphical user interface display space, a second interactive graphical object representative of one or more alert messages associated with the first oil and gas industrial machine of the plurality of oil and gas industrial machines.

12. The method of claim 11, further comprising:
receiving data characterizing user interaction with the second interactive graphical object indicative of selection of a first alert message of the one or more alert messages ;
rendering, in the graphical user interface display space, a third interactive graphical object characterizing a third input value indicative of a repair request associated with the first industrial machine;
receiving data characterizing user interaction with the third interactive graphical object; and
generating a work order for the repair request associated with the industrial machine.

13. A system comprising:
at least one data processor;
memory coupled to the at least one data processor, the memory storing instructions to cause the at least one data processor to perform operations comprising:
rendering, in a graphical user interface display space, a first interactive graphical object characterizing a first input value indicative of a first oil and gas machine of a plurality of oil and gas industrial machines;
receiving data characterizing user interaction with the first interactive graphical object and indicative of the first input value;
determining, by a predictive model, data characterizing a characteristic property of a plurality of components of the first oil and gas machine over a first time period, the determining based in part on data characterizing one or more operating parameters of the plurality of components over a second time period; and
rendering, in the graphical user interface display space, a first plot of the determined data characterizing the characteristic property over the first time period and a second plot of data characterizing the characteristic property over the second time period.

14. The system of claim 13, wherein the operations further comprise determining the data characterizing the characteristic property over the second time period from the data characterizing one or more operating parameters of the plurality of components of the first oil and gas machine.

15. The system of claim 14, wherein the operations further comprise:
generating, by the predictive model, a plurality of recommendations for the first oil and gas machine, the plurality of recommendations indicative of a plurality of predicted outputs of the plurality of components of the first oil and gas machine;
rendering, in the graphical user interface display space, one or more interactive graphical objects representative of one or more of the plurality of predicted outputs; and
receiving, from a user, data characterizing selection of one or more of the plurality of predicted outputs by the user.

16. The system of claim 15, wherein the operations further comprise:
generating, by the predictive model:
a first forecast of the characteristic property of the plurality of components over the first time period, the first forecast based on selection of a first predicted output of the plurality of predicted outputs and indicative of a first plurality of future values of the characteristic property, and
a second forecast of the characteristic property of the plurality of components over the first time period, the second forecast based on selection of a second predicted output of the plurality of predicted outputs and indicative of a second plurality of future values of the characteristic property;
rendering, in the graphical user interface display space, a first forecast plot of the first forecast of the characteristic property over the first time period, and a second forecast plot of the second forecast of the characteristic property over the first time period.

17. The system of claim 16, wherein the operations further comprise generating, by the predictive model, a third forecast of the characteristic property of the plurality of components over the first time period, the third forecast based on selection of the first predicted output and the second predicted output.

18. The system of claim 16, wherein the first forecast of the characteristic property of the plurality of components over the first time period is determined by the predictive model based on the one or more operating parameters of the plurality of components over the second time period and an input recommendation for the first oil and gas machine provided by the user.

19. The system of claim 18, wherein the operations further comprise updating the predictive model, the updating comprising determining one or more system coefficients associated with the plurality of components of the first oil and gas machines.

20. A monitoring system comprising:
a dashboard including a graphical user interface display space;
a digital twin validation system including a processor configured to perform operations comprising:
rendering, in a graphical user interface display space, a first interactive graphical object characterizing a first input value indicative of a first oil and gas machine of a plurality of oil and gas industrial machines;
receiving data characterizing user interaction with the first interactive graphical object and indicative of the first input value;
determining, by a predictive model, data characterizing a characteristic property of a plurality of components of the first oil and gas machine over a first time period, the determining based in part on data characterizing one or more operating parameters of the plurality of components over a second time period; and
rendering, in the graphical user interface display space, a first plot of the determined data characterizing the characteristic property over the first time period and a second plot of data characterizing the characteristic property over the second time period.
